(19) United States
(12) Patent Application Publication
(10) Pub. No.: US 2023/0284653 A1
(43) Pub. Date: Sep. 14, 2023

(54) Method for Producing Novel Plant-Based Whole Cut Meat Analogue

(71) Applicant: LusOasis Inc., Naperville, IL (US)

(72) Inventors: Huan Xia, Naperville, IL (US); Li Yu, Chino Hills, CA (US)

(21) Appl. No.: 18/181,616

(22) Filed: Mar. 10, 2023

Related U.S. Application Data
(60) Provisional application No. 63/318,647, filed on Mar. 10, 2022.

(51) Int. Cl. A23J 3/22; A23J 3/14; A23J 3/26

(52) U.S. Cl. CPC A23J 3/227; A23J 3/14; A23J 3/26

(57) ABSTRACT

The present invention generally relates to a method to produce plant-based whole cut meat analogues with muscle-like fibrous structure and elasticity, nutritionally balanced amino acid profile, and meaty flavors, using naturally occurring and available plant protein sources and other plant-based ingredients, without genetic engineering and cell cultivation. The present invention particularly relates to a method to provide novel processing and ingredient technology solutions to overcome multiple hurdles regarding highly imitating the taste, appearance, and texture of whole cut meat analogue products from high moisture extrusion. In addition, the invention provides formulation solutions for creating balanced amino acids and a complete protein nutritional profile in whole cut meat analogues comparable to animal meat. The invention further provides commercialization and sustainability solutions to enable cost-efficient and fast scale-up for whole cut meat analogues production, with much higher sustainability metrics as compared to traditional animal meat production. The present invention also relates to a plant-based whole cut meat analogue produced according to the invented method, with versatile forms and flavors suitable for imitating meat products from different animal origins.

The current application claims a priority to the U.S. Provisional Patent application Ser. No. 63/318,647 filed on Mar. 10, 2022.

### FIELD OF THE INVENTION

The present invention relates generally to a method for producing a plant-based meat analogue. More specifically, the present invention relates to a method to produce plant-based whole cut meat analogues with muscle-like fibrous structure and elasticity, nutritionally balanced amino acid profile, and meaty flavors, using naturally occurring and available plant protein sources and other plant-based ingredients, without genetic engineering and cell cultivation.

### BACKGROUND OF THE INVENTION

Plant-based meats are among the fastest-growing foods in the food industry today and have attracted many innovations. The successful applications in the market comprising various ground meat analogue formats, burger patties, sausages, meat balls, nuggets, etc., have accelerated the market growth of plant-based meat alternatives, which market value reached $1.4 billion in 2020 in the US alone, a 45% increase from $962 million in 2019. The most difficult challenge remains to develop muscle-like fibers that will deliver the firm bite and elasticity that consumers expect from a steak or alike whole cut meats. 60% of animal meat consumption is in whole cut format, which translates to 66 billion pounds of meats per year in the US alone and presents the biggest gap of the alternative protein industry. Plant-based whole cut meat analogue is the alternative protein product most in demand and would bring the ultimate solution for acceptance by meat-eater consumers today to reduce meat intake and environmental carbon footprint.

There are 3 major hurdles to bringing plant-based whole cut meat to market: texture and taste, affordability, and scalability. A few whole-cut meat analogues made from mycoprotein have reached technical feasibility and commercial scale, but they're perceived as dry and dissimilar to the fibrous meat texture. Many others are developing cultivated meat from the lab through cellular agriculture, and some of them involve genetically modified organism approaches. Although small-scale lab prototypes from the cultivated meat appear promising to imitate animal meat texture and taste, current evidence shows that cultivated meat development requires a long-time duration and intensive capital investment before reaching commercial scale production and achieving comparable pricing structure with animal meat. On the other hand, a possible quickest way to achieve acceptable affordability and scalability is through employing naturally occurring plant proteins that are readily available and economically feasible, with no need for genetic engineering, and no long wait for cell cultivation.

### SUMMARY OF INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention provides a method to produce plant-based whole cut meat analogues with muscle-like fibrous structure and elasticity, nutritionally balanced amino acid profile, and meaty flavors, using naturally occurring and available plant protein sources and other plant-based ingredients, without genetic engineering and cell cultivation.

Various objects and advantages of this method and its product attributes will become apparent from the following descriptions taken in conjunction with the accompanying illustrations and examples, certain embodiments of the process and resulting compositions.

In one aspect, the invention provides dynamic formulations of the raw ingredient combination from assorted plant proteinaceous materials, including 20% to 90% protein content at dry weight basis, to simulate the essential amino acid composition of the protein content of meat analogue to that of respective animal protein, such as beef, chicken, pork, lamb, etc.; and inclusion of various ingredients for flavoring, coloring, batter thickening, and stabilization for simulating desired meaty taste from different conventional animal meats, as well as for minimizing beany taste and off notes from plant protein sources. The protein sources can be extended to include proteins from yeast, fish, chicken, and beef to achieve similar muscle-like fibrous structure.

In another aspect, the present invention comprises a high moisture extrusion process at a water content of 35%-80% to create elongated and solidified protein fibrous structure at desired toughness and chewiness to simulate whole cut meat, wherein a precisely designed extrusion process is used to sufficiently expand protein structures, with temperature starting at 30° C.-50° C., incrementally increasing from 80° C.-90° C. to 140° C.-150° C., keeping ramping up until it reaches the highest temperature range around 160° C.-175° C., then ramping down to 130° C.-150° C. and tapering off around 110° C.-120° C., and followed by a cooling process that lowers extrudate temperature to around 70° C. over multiple segments to realign, solidify, and form elongated and layered protein fiber molecular structure along the laminar flow, and then produces cooled extrudate of 5-15 mm thickness through either flat or circular shaping dies.

In another aspect, the present invention provides novel post processes to create desired texture, flavor, and appearance from the high moisture extrudate product for various plant-based whole cut meat applications. In some embodiments, the extrudate product is shaped and prepared to mimic natural meat appearance with irregular shapes and various whole cut meat analogue forms, such as but not limited to meaty chunks, sliced beef steak, pulled meat, and schnitzel. In some embodiments, the extrudate product is conditioned to partially expand the dense fibrous structure for easy flavor incorporation. In some embodiments, proteolytic enzymes, selected from endopeptidases, exopeptidases, endoproteases, exoproteases, endogenous enzymes, exogenous enzymes, and combinations thereof, are contacted with extrudate product to allow a suitable amount of reaction time, and the protein in the substrate is hydrolyzed into peptides or amino acids to promote meaty flavor creation through Maillard reaction and to create tender texture and juicy mouthfeel. In some embodiments, the extrudate product is infused with well-rounded natural flavor combinations or is treated to generate reactions flavors to simulate animal meat flavors. In some embodiments, the extrudate product is modified to form whole cut meat analogues with fat like texture and sufficient thickness.

In another aspect, the present invention describes a cost-efficient financial model to show that the invented whole cut meat analogue can be produced within hours and scaled up easily to provide abundant supply, with similar affordability but much higher sustainability metrics than traditional animal meats.

In another aspect of the present invention, the composition of a plant-based whole cut meat analogue is provided, which comprises about 11%-45% by weight of protein content, and about 35%-70% by weight of water, tight-layered elongated protein anisotropic fiber with large longitudinal strength and laminar shape of about 5-15 mm of thickness, and greater thickness created through restructuring and crosslinking meat analogue with imitation fat upon novel post-processing, similar juiciness, firmness, elasticity, appearance, and protein nutritional value in comparison to animal meat equivalent, layered sophisticated flavor profiles from the inside matrix to the outside topical flavor mimicking organoleptic satisfaction from animal meat taste, and versatile shapes, forms, and flavors suitable for various plant-based whole cut meat applications from different animal origins.

The value proposition of this invention lies in its multiple hurdle creation through integrating both processing and ingredient technology, to successfully simulate animal whole cut meat texture, taste, appearance, and protein nutritional value, as well as in its fast scalability and high affordability for commercialization and various whole cut meat applications. The products disclosed in this invention not only meet consumers' organoleptic satisfaction toward real whole cut meat expectation, but also suffice their nutritional needs for the human body's essential amino acid requirement. In addition, the invention provides commercialization financial model for cost efficiency of integrated supply chain from farm to fork including ingredients, manufacturing, storage, and distribution.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE PRIOR ART

As meat alternatives become increasing popular, the lack of fully plant-based meat substitutes with muscle-like fibrous structure and elasticity, nutritionally balanced amino acid profile, and meaty flavors becomes increasing apparent. The current meat substitutes and methods of producing meat substitutes do not meet the needs the continuously growing market, and this invention intends to meet these long-felt but unsolved needs. The following prior art are considered some of the most similar to the current invention; however, there are crucial differences that make the current invention novel and uniquely suited to meet the needs of the consumer.

US20120251686A1 teaches a product and method for producing meat-like analogues. The specification describes a flavor stabilized hydrated texturized plant protein that may be produced by infusing dehydrated texturized plant protein particles with a water solution of one or more flavors and one or more heat denaturable soluble proteins. A binding and thickening water solution, including a heat denaturable soluble protein, a gum, an insoluble food protein, and/or a starch, may be added to the flavor stabilized hydrated texturized plant protein to create a formable mass. Fat may be added to the formable mass to produce a mass of generally moist crumbly pieces, wherein the crumbly pieces are generally surrounded by the binder/thickener.

US20150289542A1 teaches a method for texturing vegetable fibers and proteins. The invention relates to a method for providing a meat substitute composition, comprising providing plant fibers having a water content of at least 1 wt. % and mixing with vegetable protein, followed by extruding the homogeneous dough in a co-rotating twin screw extruder having intermeshing screws under the addition of water, and texturing the extrudate in a container wherein the extrudate is subjected to a temperature of between 50° C. to 120° C. and a pressure of between 10 to 70 bar for a time period of 2 to 20 minutes, thereby providing the meat substitute composition.

Both of the prior art listed above are missing key components of the current invention. In US20120251686A1, the main ingredient is texturized vegetable proteins (TVP) from low moisture extrusion, whereas the current invention uses high moisture extrusion. The products in this prior art are ground meat analogues, whereas the current invention is whole cut. Additionally, the prior art includes the use of egg whites, whereas the current invention is fully plant-based and vegan. In US20150289542A1, the specification contains no description of product features such as protein fiber structure, organoleptic flavors, or meaty texture. However, in the current invention, those characteristics are disclosed and described completely.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, the applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF DESCRIPTION OF THE DRAWINGS

FIG. 1 is a flow diagram of the present invention for a method for producing plant-based whole-cut meat analogues.

FIG. 2 is a chart comprising a formulation process and a list of plant proteinaceous materials, flavoring and coloring ingredients, and thickening and stabilizing ingredients, thereof.

FIG. 3 is chart comprising a list of plant proteinaceous materials thereof.

FIG. 4 is chart comprising a list of flavoring and coloring ingredients thereof.

FIG. 5 is chart comprising a list of thickening and stabilizing ingredients thereof.

FIG. 6 is a flow diagram showing a pretreatment process of the present invention.

FIG. 7 is a flow diagram showing a high moisture extrusion and cooling process thereof.

FIG. 8 is a flow diagram showing a high moisture extrusion process thereof.

FIG. 9 is a flow diagram showing a cooling process thereof.

FIG. 10 is a flow diagram showing a reaction flavor generation process thereof.

FIG. 11 is a diagram showing an alternative embodiment of the present invention, wherein said embodiment occurs in between a conditioning of protein fibrous structures process and a high pressure cooking process thereof.

FIG. 12 is a list of endogenous enzymes as in one embodiment of the present invention.

FIG. 13 is a flow diagram of a microwave vacuum heating process of the present invention.

FIG. 14A is a flow diagram for creating a meat analogue as described in one embodiment of the present invention.

FIG. 14B is a list of vegetable fats and oils as discussed in one embodiment of the present invention.

FIG. 15A is a list of ingredients in which a mixture of fat and oil is emulsified as in the present invention.

FIG. 15B is a list of hydrocolloids of the present invention.

FIG. 16 is a commercialization sustainability model, in accordance with some embodiments.

FIG. 17 is a formulation of proteinaceous raw materials to simulate the essential amino acid profile from beef brisket, in accordance with some embodiments.

FIG. 18 is an exterior perspective view of a plant-based whole cut meat analogue from high moisture extrusion and cooling process, in accordance with some embodiments.

FIG. 19 is an interior perspective view of a plant-based whole cut meat analogue from high moisture extrusion and cooling process, in accordance with some embodiments.

FIG. 20 is an interior perspective view of a plant-based whole cut meat analogue from high moisture extrusion and cooling process, in accordance with some embodiments.

FIG. 21 is an interior perspective view of a partially opened fiber structure from the expanded extrudate product of a plant-based whole cut meat analogue, in accordance with some embodiments.

FIG. 22 is an exterior perspective view of mechanically torn pieces from the expanded extrudate product of a plant-based whole cut meat analogue, in accordance with some embodiments.

FIG. 23 is an exterior perspective view of a ready-to-eat plant-based whole cut meat analogue to simulate beef brisket, in accordance with some embodiments.

FIG. 24 is an exterior perspective view of a ready-to-eat plant-based whole cut meat analogue to simulate beef brisket, in accordance with some embodiments.

FIG. 25 is an exterior perspective view of a ready-to-eat plant-based whole cut meat analogue to simulate beef brisket, in accordance with some embodiments.

FIG. 26 is an interior perspective view of protein fiber appearance from a ready-to-eat plant-based whole cut meat analogue, in accordance with some embodiments.

FIG. 27 is an interior perspective view of enlarged protein fiber structure from a ready-to-eat plant-based whole cut meat analogue (2 right images), muscle meat from beef (top left image), and muscle meat from pork (bottom left image), in accordance with some embodiments.

FIG. 28 is an exterior perspective view of a plant-based whole cut meat analogue in cheesesteak sandwich application, in accordance with some embodiments.

### DETAIL DESCRIPTIONS OF THE INVENTION

The accompanying drawings, which are incorporated in and constitute a part of this disclosure, illustrate various embodiments of the present disclosure. The drawings contain representations of various trademarks and copyrights owned by the applicants.

In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with the reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

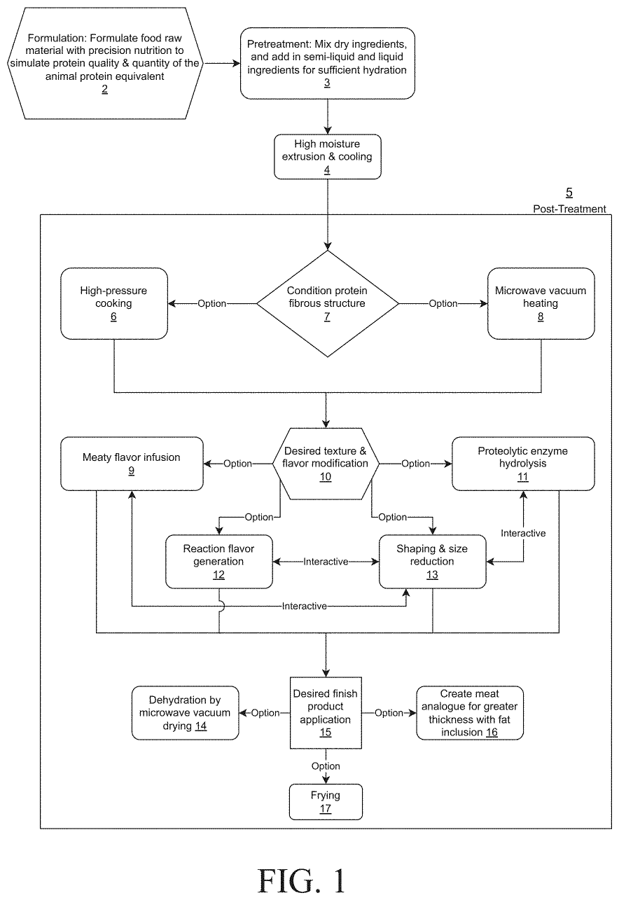

The present invention is a method for producing plant-based whole-cut meat analogues comprising formulation 2, pretreatment 3, high moisture extrusion and cooling 4, post-treatment 5 and flavor generation 12. The method may be carried out via a continuous, batch-wise, or a combination of both types of processing. A flow diagram, as shown in FIG. 1, illustrates the steps of the present invention in the preferred embodiment.

Formulation 2

As shown in FIG. 1, the present invention comprises formulation 2 wherein a raw food material for producing plant-based whole-cut meat analogues is formulated with the group comprising an at least one plant proteinaceous material 21, that also contains carbohydrate material such as fiber and starch, an at least one flavoring and coloring ingredient 22, an at least one thickening and stabilizing ingredient 23, and water. Some preferred embodiments, formulation 2 does not challenge common nutritional sensitivities such as gluten or soy.

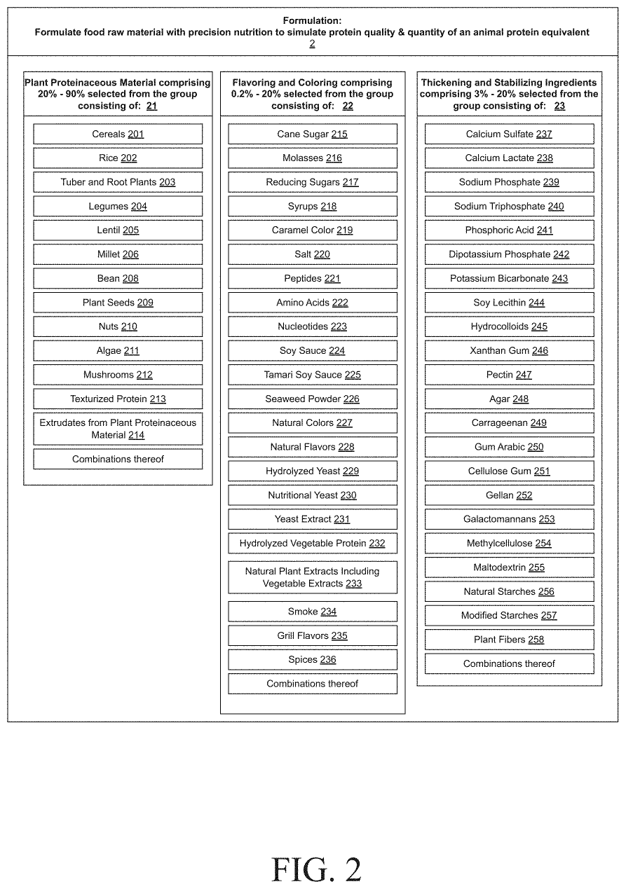

The preferred inclusion range of the food raw material at dry weight basis, as shown in FIG. 2, includes about 20% to about 90% protein content from plant proteinaceous material 21, about 0.2% to about 20% flavoring and coloring ingredients 22, and about 3% to about 10% thickening and stabilizing ingredients 23. The inclusion range is dependent on the simulation product target, including but not limited to the specific amino acid profile from certain animal meat such as beef, chicken, pork, lamb, and the whole cut meat texture and taste requirements such as for meaty chunks, steak, pulled meat, schnitzel, and more. The addition of such flavoring and coloring ingredients 22 is important to minimize beany taste or other off notes from plant proteinaceous materials 21 and is effective to create desired flavor and color base throughout the extrudate product.

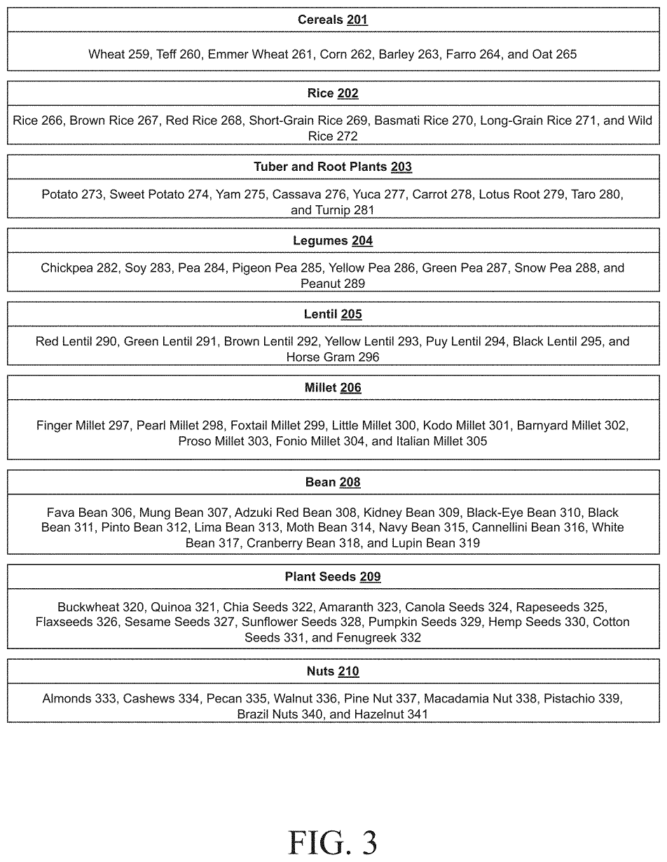

In the preferred embodiment of the present invention, the plant proteinaceous materials 21, as shown in FIG. 2 and FIG. 3, are selected from, but not limited to cereals 201 such as wheat 259, teff 260, emmer wheat 261, corn 262, barley 263, farro 264, oat 265, rice varieties 202 such as rice 266, brown rice 267, red rice 268, short-grain rice 269, basmati rice 270, long-grain rice 271, and wild rice 272; tuber and root plants 203 such as potato 273, sweet potato 274, yam 275, cassava 276, yuca 277, carrot 278, lotus root 279, taro 280, turnip 281; legumes 204 such as chickpea 282, soy 283, pea 284, pigeon pea 285, yellow pea 286, green pea 287, snow pea 288, peanut 289, lentil varieties 205 such as red lentil 290, green lentil 291, brown lentil 292, yellow lentil 293, puy lentil 294, black lentil 295, and horse gram 296, millet varieties 206 such as finger millet 297, pearl millet 298, foxtail millet 299, little millet 300, kodo millet 301, barnyard millet 302, proso millet 303, fonio millet 304, and Italian millet 305, bean varieties 208 such as fava bean 306, mung bean 307, adzuki red bean 308, kidney bean 309, black-eye bean 310, black bean 311, pinto bean 312, lima bean 313, moth bean 314, navy bean 315, cannellini bean 316, white bean 317, cranberry bean 318, lupin bean 319; plant seeds 209 such as buckwheat 320, quinoa 321, chia seeds 322, amaranth 323, canola seeds 324, rapeseeds 325, flaxseeds 356, sesame seeds 327, sunflower seeds 328, pumpkin seeds 329, hemp seeds 330, cotton seeds 331, fenugreek 332; nuts 210 such as almonds 333, cashews 334, pecan 335, walnut 336, pine nut 337, macadamia nut 338, pistachio 339, Brazil nuts 340, hazelnut 341; algae 211, mushrooms 212, extrudates from plant proteinaceous material 214, texturized protein 213, and combinations thereof.

In consideration of broader animal-free protein sources from fermentation technology and cellular cultivation, proteins from yeast, fish, chicken, and beef are also examined in the formulations together with plant protein sources to demonstrate the feasibility of using the processing and formulation described herein in creating a unique muscle-like fibrous texture from broader protein sources.

A ratio and inclusion level of the plant proteinaceous material 21, and combinations thereof, are precisely engineered to simulate an essential amino acid composition of a protein content of an animal meat analogue to that of a respective animal protein, such as chicken, pork, beef, and lamb. Such novel nutritional engineering would ensure similar protein quality and value to consumers as to their animal protein equivalent.

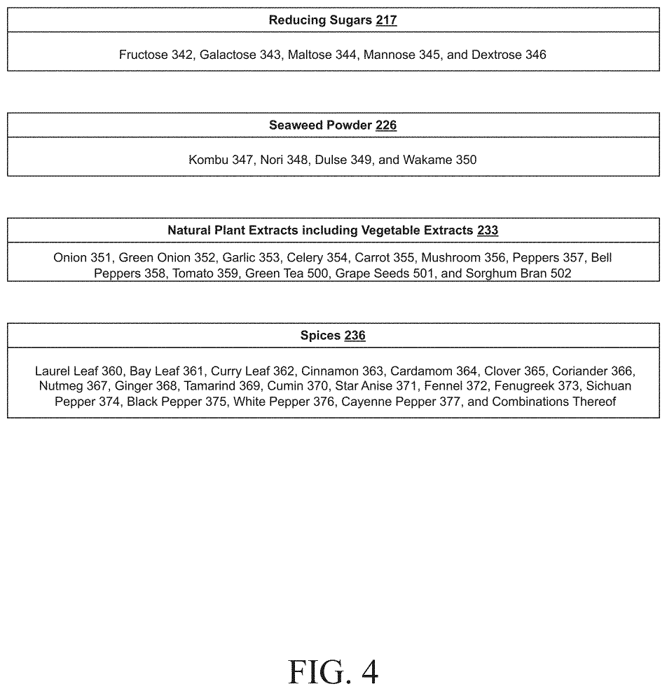

In the preferred embodiment of the present invention, as shown in FIG. 2 and FIG. 4, flavoring and coloring ingredients 22 are selected from, but not limited to cane sugar 215, molasses 216, reducing sugars 217 such as fructose 342, galactose 343, maltose 344, mannose 345, and dextrose 346; syrups 218, caramel color 219, salt 220, peptides 221, amino acids 222, nucleotides 223, soy sauce 224, tamari soy sauce 225, seaweed powder 226 from such as kombu 347, nori 348, dulse 349, and wakame 350; natural colors 227, natural flavors 228, hydrolyzed yeast 229, nutritional yeast 230, yeast extract 231, hydrolyzed vegetable protein 232, natural plant extracts including vegetable extracts 233 such as but not limited to green tea 500, grape seeds 501, sorghum bran 502, onion 351, green onion 352, garlic 353, celery 354, carrot 355, mushroom 356, peppers 357, bell peppers 358, and tomato 359; smoke 234 and grill flavors 235, spices 236 such as laurel leaf 360, bay leaf 361, curry leaf 362, cinnamon 363, cardamom 364, clover 365, coriander 366, nutmeg 367, ginger 368, tamarind 369, cumin 370, star anise 371, fennel 372, fenugreek 373, Sichuan pepper 374, black pepper 375, white pepper 376, cayenne pepper 377, and combinations thereof.

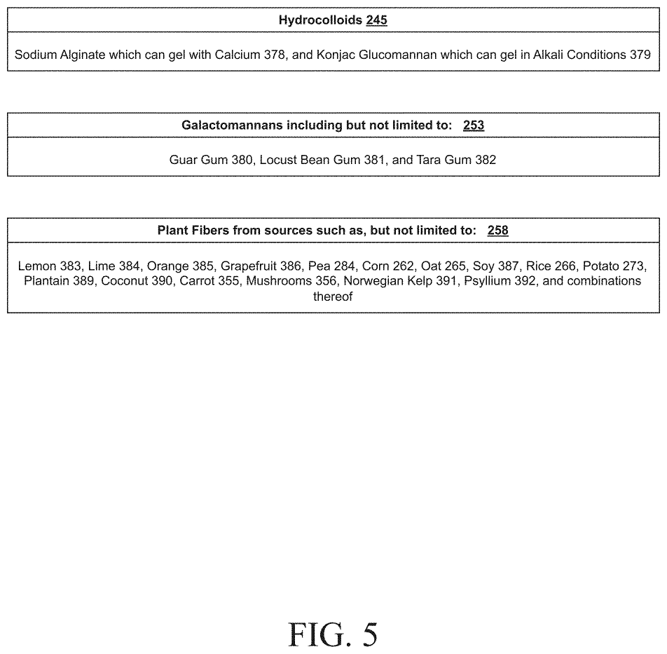

In the preferred embodiment of the present invention, as shown in FIG. 2 and FIG. 5, the preferred thickening and stabilizing ingredients 23 are selected from, but not limited to calcium sulfate 237, calcium lactate 238, sodium phosphate 239, sodium triphosphate 240, phosphoric acid 241, dipotassium phosphate 242, potassium bicarbonate 243, soy lecithin 244, hydrocolloids 245 such as sodium alginate which can gel with calcium 378, konjac glucomannan which can gel in alkali condition 379, xanthan gum 246, pectin 247, agar 248, carrageenan 249, gum Arabic 250, cellulose gum 251, gellan 252, galactomannans 253 including but not limited to guar gum 380, locust bean gum 381, and tara gum 382, methylcellulose 254, maltodextrin 255, natural starches 256, modified starches 257, plant fibers 258 from sources such as but not limited to lemon 383, lime 384, orange 385, grapefruit 386, pea 384, corn 262, oat 265, soy 387, rice 266, potato 273, plantain 389, coconut 390, carrot 355, mushrooms 356, Norwegian kelp 391, psyllium 392, and combinations thereof, which can improve binding strength, water retention and textural stability of meat analogue under freezing condition or temperature fluctuation during storage and transportation.

Pretreatment 3

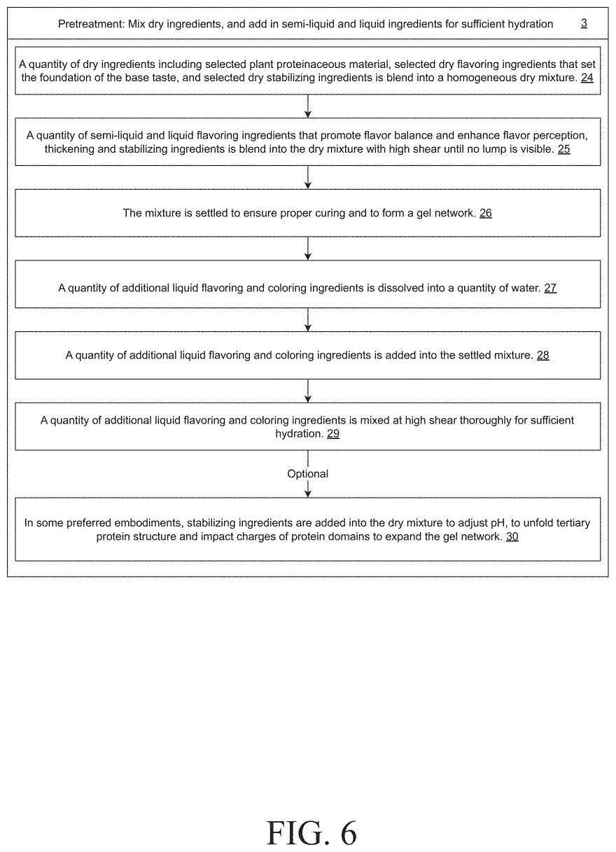

Pretreating 3, as shown in FIG. 6, comprises a method wherein said method produces a mixture referred to as a pretreated mixture. A quantity of dry ingredients including selected plant proteinaceous material 21, selected dry flavoring ingredients 22 that set a foundation of a base taste, and selected dry stabilizing ingredients 23 are blended into a homogeneous dry mixture 24. A quantity of semi-liquid and liquid flavoring ingredients 22 that promote flavor balance and enhance flavor perception, thickening and stabilizing ingredients 23 is blended into said dry mixture with high shear until no lumps are visible 25, and settled to ensure proper curing and to form a gel network and a settled mixture 26. A quantity of additional liquid flavoring and coloring ingredients 22, such as, but not limited to soy sauce 224, tamari soy sauce 225, and caramel color 219, is dissolved into a quantity of water 27, added into the settled mixture 28, and mixed at high shear thoroughly for sufficient hydration 29. In some alternate embodiments of the present invention, stabilizing ingredients are added into the dry mixture to adjust pH, to unfold tertiary protein structure and impact charges of protein domains to expand the gel network 30.

High Moisture Extrusion and Cooling 4

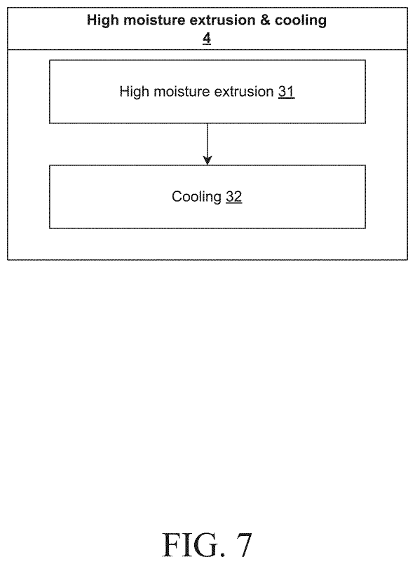

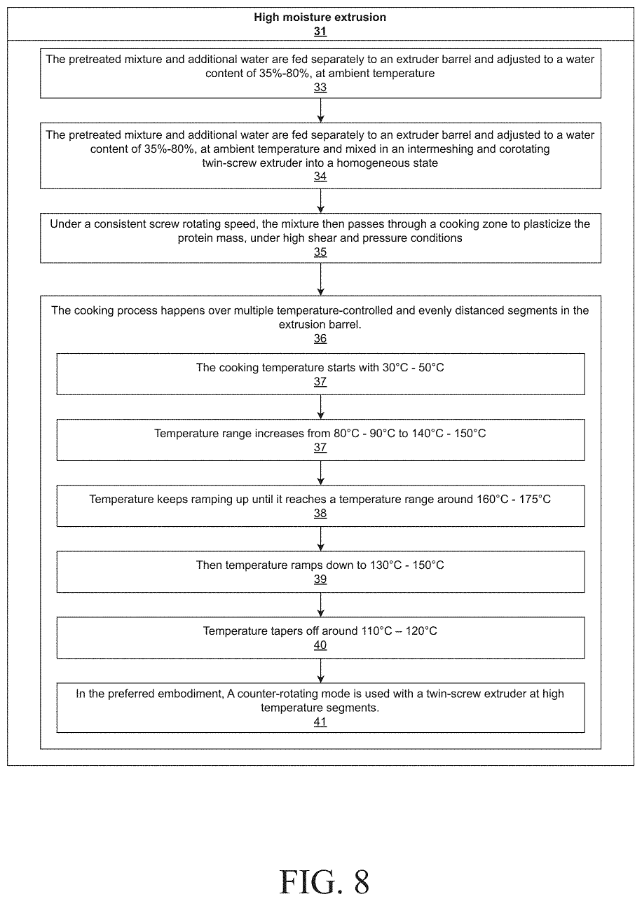

In the high moisture extrusion and cooling process 4, as shown in FIG. 7 and FIG. 8, the pretreated mixture and additional water are fed separately, at a predetermined feeding speed, into an extruder barrel and adjusted to a water content of 35%-80%, at ambient temperature 33, and mixed in an intermeshing and corotating twin-screw extruder, at a predetermined screw rotating speed, into a homogeneous state, creating a resultant mixture 34. Under a consistent screw rotating speed, the resultant mixture then passes through a cooking zone to plasticize a protein mass, under high shear and pressure conditions 35. The ingredient feeding speed, screw rotation speed, and extruder barrel pressure are precisely controlled according to the extruder, comprising an extruder size to achieve desired extrudate attributes. A cooking process happens over multiple temperature-controlled and evenly distanced segments in the extrusion barrel 36. The cooking temperature starts with 30° C.-50° C. 37, continues with incremental temperature range increasing from 80° C.-90° C. to 140° C.-150° C. 18, keeps ramping up until it reaches the highest temperature range around 160° C.-175° C. 38, then ramps down to 130° C.-150° C. 39 and tapers off around 110° C.-120° C. 40. The increases and decreases in temperature are separately controlled through electricity and water, respectively. In the preferred embodiment of the present invention, a counter-rotating mode is used for the twin-screw extruder at high temperature segments 41, to slow down the mixture transfer rate to increase cooking time, allowing more sufficient expansion of protein molecules and subsequently stronger fiber structure and network, supported by disulfide bonds interaction with noncovalent interactions such as hydrogen, hydrophobic, and ionic linkages. Despite the occurrence of high shear stress during extrusion, a high moisture content in the mixture may dissipate the mechanical energy to protect amino acid profile in the extruded plant protein, preserving a nutritional value in an original unextruded protein.

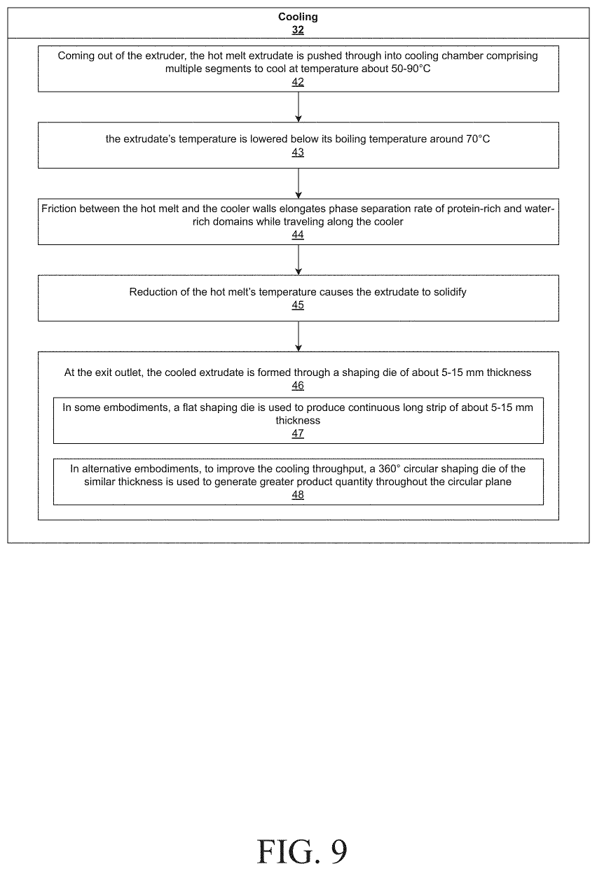

In the cooling process 32 of the high moisture extrusion and cooling process 4, as shown in FIG. 7 and FIG. 9, a hot melt extrudate, a product formed by way of the high moisture extruding process 31, as shown in FIG. 8, is pushed through into a cooling chamber consisting of multiple segments to cool at a temperature of about 50-90° C. 42, where the extrudate's temperature is lowered below its boiling temperature of around 70° C. 43 to avoid rapid expansion which would otherwise occur under ambient pressure conditions at an extruder outlet. Friction between the hot melt and the cooling chamber walls elongates a phase separation rate of protein-rich and water-rich domains while traveling along the cooling chamber 44. Further reduction of the hot melt's temperature causes it to solidify, creating a solidified and elongated protein-rich domain 45. The solidified and elongated protein-rich domains bear similarity to the fibrous structure of animal flesh, allowing layered fibrous protein structure formation through protein new structure formation, protein-water phase separation, and realignment of molecular structure along a direction similar to that of a laminar flow. Particular shear and temperature gradients are created during the cooling process to reach a desired heat conduction rate and a predetermined flow rate to enable proper phase separation rate, critical for simulating a muscle-like fibrous structure. At the exit outlet, a cooled extrudate is formed through a shaping die of about 5-15 mm thickness 46 to allow quick heat dissipation. A flat shaping die can be used to produce a plurality of continuous long strips of about 5-15 mm thickness 47. In alternate embodiments, a 360° circular shaping die of similar thickness can be used to generate greater product quantity throughout the circular plane, which creates a bigger surface area than a flat plane 48.

During the extrusion process, the mixture goes through a hot melt, a velocity flowing profile, a nucleation process, and a phase formation. The property of the final cooled extrudate is impacted by multivariable factors including a product formula, a water content, a cooking temperature, a shear rate, a flow rate, a cooling temperature gradient, a screw profile, the ratio of a flighted length of the screw to an outside diameter of said screw, a cooling die size and a die shape.

The impact of the highest extrusion temperature on extrudate physicochemical change during the extrusion process is studied to optimize the longitudinal strength and fiber structure organization during the anisotropic fiber formation. The impact of mushroom stem fiber and extrudates from highland barley is found to have a positive effect on fiber structure formation and anti-freeze properties. Particularly it is shown to have enhanced fiber tightness, pore size and moisture retention, under microscopy and texture profile analysis. The impact of different ratios of legume proteins and wheat gluten on extrudate sensory properties and elasticity is also examined to find the optimal composition to simulate muscle fiber formation. Different ratios of protein and carbohydrate are used for formulation 2 studies and found to show an impact on fibril protein formation and texture toughness, which are required features for simulating various types of animal meat, and optimal protein composition is identified from microscopic comparison of fibrous structure morphology from the extrudate. When plant proteins are blended with proteins from yeast, fish, chicken, and beef, the extrudate also shows a unique muscle-like fibrous texture and demonstrates the broader application of the disclosure herein.

Post-Treatment 5 and Flavor Generation 12

The cooled extrudate product has a moisture content of 35%-70%, a protein content of 11%-45%, a tight layered fibrous structure, and a meat-like elasticity. Said product can be frozen into a core temperature of less than −18° C. for longer-term use, with minimal impact on a product elasticity, an appearance, and a flavor, only slightly increasing a hardness. The solidified product, comprising a plurality of fibers, wherein said fibers in the cooled extrudate are highly organized, dense, and in some embodiments of the present invention, rubbery. Various post-processing methods listed in the following descriptions are examined to open the dense fibrous structure at a desired amount, enabling effective flavor infusion into the extrudate product to simulate animal meat flavors while creating a tender and juicy mouthfeel in addition to the chewy and firm texture. These methods can be used singly or in different combinations or sequences, either to open fibrous structure, or to create a desired flavor, or for both purposes, depending on the finished product application. In addition, the product can be cut, torn, or shaped into various whole cut meat analogue forms, such as but not limited to meaty chunks, sliced beef steak, pulled meat, and schnitzel.

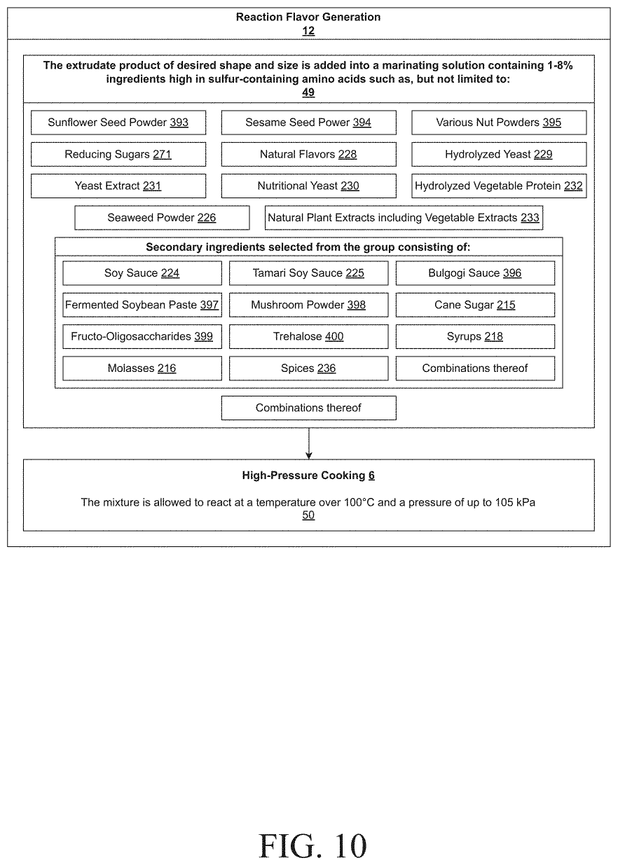

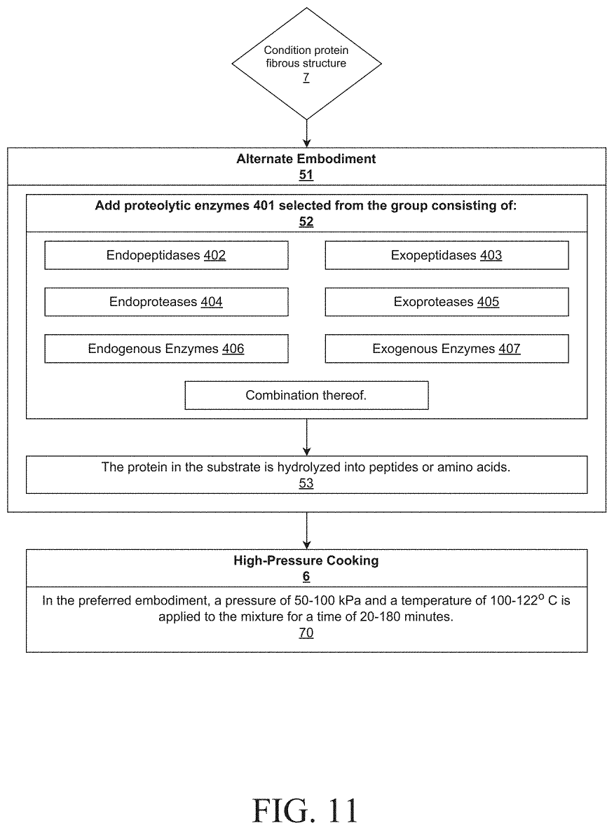

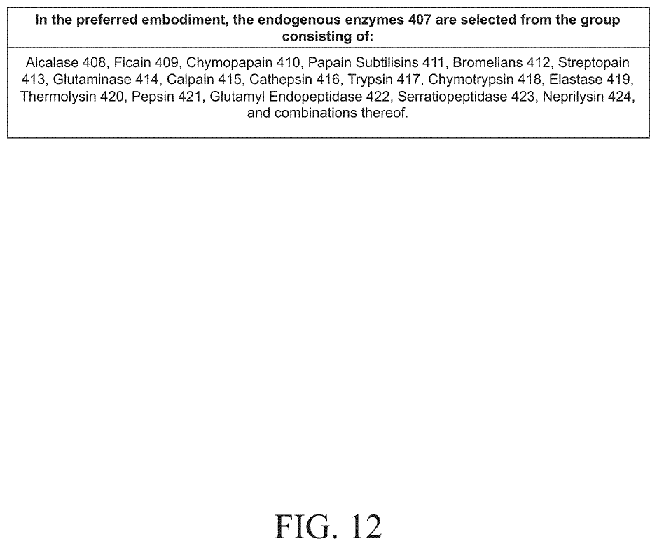

The present invention comprising a high pressure cooking 6 method and reactive flavor generation 12 method, as shown in FIG. 10, is found to be effective to soften and open dense fibrous structures and incorporate flavor into the core of the product. The extrudate product of desired shape and size is added into a marinating solution 49 containing 1-8% ingredients high in sulfur-containing amino acids such as, but not limited to sunflower seed powder 393, sesame seed powder 394, and various nut powders 395, together with reducing sugars 271 such as fructose 342, galactose 343, maltose 344, mannose 345, and dextrose 346, natural flavors 228, hydrolyzed yeast 229, yeast extract 231, nutritional yeast 230, hydrolyzed vegetable protein 232, seaweed powder 226 from such as kombu 347, nori 348, dulse 349, and wakame 350, natural plant extracts including vegetable extracts 233 such as but not limited to green tea 500, grape seeds 501, sorghum bran 502, onion 351, green onion 352, garlic 353, celery 354, carrot 355, mushroom 356, peppers 357, bell peppers 358, and tomato 359, smoke 234 and grill flavors 235, and ingredients selected from the group consisting of soy sauce 224, tamari soy sauce 225, bulgogi sauce 396, fermented soybean paste 397, mushroom powder 398, cane sugar 215, fructo-oligosaccharides 299, trehalose 400, syrups 218, molasses 216, spices 236 such as laurel leaf 360, bay leaf 361, curry leaf 362, cinnamon 363, cardamom 364, clover 365, coriander 366, nutmeg 367, ginger 368, tamarind 369, cumin 370, star anise 371, fennel 372, fenugreek 373, Sichuan pepper 374, black pepper 375, white pepper 376, cayenne pepper 377; and combinations thereof. In the high-pressure cooking 6 process as shown in FIG. 10, the mixture is allowed to react at high temperature of over 100° C. and high pressure of up to 105 kPa to create reaction meaty flavor notes and infuse such flavor into the product. In an alternative embodiment, as shown in FIG. 11, proteolytic enzymes 401, selected from endopeptidases 402, exopeptidases 403, endoproteases 404, exoproteases 405, endogenous enzymes 406, exogenous enzymes 407, and combinations thereof, are added 52 before the high-pressure cooking 6 treatment to allow a suitable amount of reaction time, and the protein in the substrate is hydrolyzed into peptides 53 or amino acids to promote meaty flavor creation through Maillard reaction. In addition, such enzyme hydrolysis at the protein molecular structure level opens the inner structure and results in desired tender product meaty texture. The intricately opened molecular structure also provides an affinity network to effectively assemble flavoring juice and fat within the protein matrix, highly mimicking the juicy and fatty mouthfeel of real meat. Preferred endogenous enzymes, as shown in FIG. 12, are selected from alcalase 408, ficain 409, chymopapain 410, papain subtilisins 411, bromelians 412, streptopain 413, glutaminase 414, calpain 415, cathepsin 416, trypsin 417, chymotrypsin 418, elastase 419, thermolysin 420, pepsin 421, glutamyl endopeptidase 422, serratiopeptidase 423, neprilysin 424, and combinations thereof. Preferably, 50-100 kPa pressure over a temperature of 100-122° C. is applied during a cooking time of about 20-180 minutes 70, depending on the amount of solution, product quantity, and the animal protein flavor profile to simulate. Volatiles, semi-volatiles, and other chemical compositional attributes are measured to correlate the flavor performance to that of respective animal protein, such as beef, chicken, pork, and lamb, and reaction ingredients and pressure and temperature conditions are adjusted to generate desired flavor performance for the animal meat to simulate.

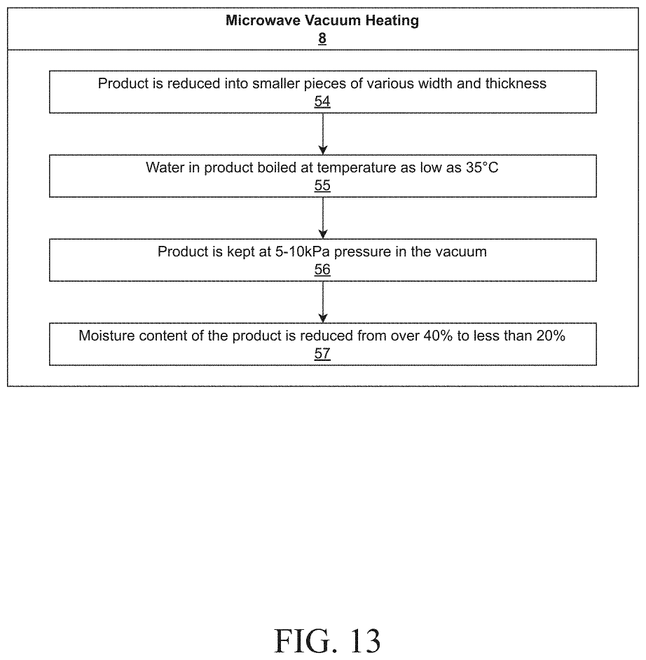

Microwave vacuum heating 8 and drying, as shown in FIG. 13, is another effective method. Microwave vacuum heating 8 combines the advantage of microwave radiation heating and vacuum drying to generate steam at a lower temperature, allowing rapid heat and mass transfer for an increased drying rate. The water in the product could be boiled at a temperature as low as 35° C. 55 to preserve food product vitamins and taste. The moisture is turned into vapor in the whole matrix of the product, and the sealed surface layer of the product would cause a sufficient increase in the pressure of vapor within the product to expand the fibrous material rapidly and form a porous structure. Before the process, the product can be size reduced into pieces of variable width and length for desired application needs 54, much larger in dimension than the piece thickness. Preferably, 10-30 kW output power which can be lowered in the later part to reduce burning heat, and 2000-3000 MHz of frequency can be used from the microwave, and the product is kept at 5-10 kPa pressure in the vacuum 56 during the process to achieve suitable evaporation rate. Depending on the size of the vacuum chamber, the processing time is controlled to achieve a desired partial expansion of the dense fiber structure mainly around the piece thickness, while reducing the moisture content of the product from over 40% to less than 20% 57. After the heating and drying process, the elasticity of the product remains, and the partially opened fiber structure promotes more efficient juicy flavor infusion without the need for extensive or high-pressure cooking 6.

In an alternative embodiment of the present invention, the fibrous structure of the extrudate product can be expanded through microwave heating without vacuum by creating temperature and pressure differences. The extrudate product of variable width and length, much larger in dimension than the piece thickness, is heated in a microwave with vented capability at proper output power, allowing sufficient expanding while minimizing burning heat trapped at specific spots. The output power of the microwave may be adjusted to avoid overheating and burning. The product is heated until the desired degree of expansion is achieved, or its thickness is expanded to about double its original size.

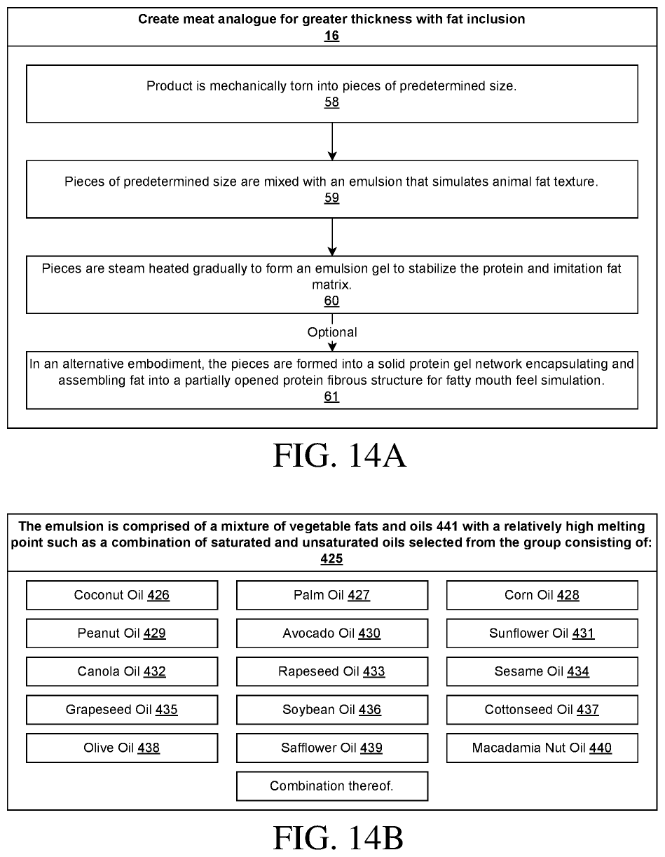

In the preferred embodiment of the present invention, as shown in FIG. 14A, the dense protein fibrous structure can first be partially opened by microwave vacuum heating and drying, then the product can be torn mechanically into pieces of desirable sizes 58 for various whole cut meat analogue forms, such as but not limited to meaty chunks, sliced beef steak, pulled meat, and schnitzel. Such a process creates irregular shapes and natural meat look, and the porosity in the expanded structure allows more energy and time-efficient flavor infusion into the meat analogues.

Natural flavors simulating animal meat flavors at a usage level of 0.5%-8% weight basis in the final product can be used for marinating, cooking, or surface rubbing for flavor infusion into the expanded protein structure, preferably at 105° C. for 20 minutes to sterilize the product as well as to infuse flavors. Preferably, a combination of base, middle, and top notes flavors are used to create well-rounded flavor profile. The expanded protein structure is found to be conducive to absorbing and retaining flavoring juice, and effective for masking and minimizing beany off taste from plant proteins throughout the product matrix into the core, while maintaining the firmness and elasticity of the texture. Sensory evaluation of the flavored product is performed to rate its juiciness, firmness, and elasticity in comparison to animal meat equivalent. The meat analogues demonstrated layered sophisticated flavor profiles from the inside matrix to the outside topical flavor which results in enhanced organoleptic satisfaction.

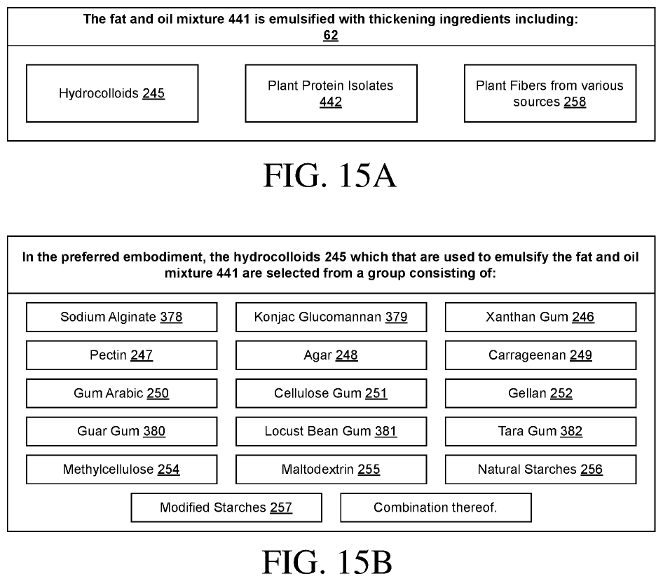

Furthermore, as also shown in FIG. 14A, the product with expanded protein structure can be mechanically torn into desirable pieces 58, mixed with an emulsion that simulates animal fat texture 59, steam heated gradually to form an emulsion gel to stabilize the protein and imitation fat matrix 60, and can be eventually formed into a solid protein gel network encapsulating and assembling fat into the partially opened protein fibrous structure for fatty mouth feel simulation 61. The imitation fat emulsion, as shown in FIG. 14B, is comprised of a mixture of vegetable fats and oils 441 with a relatively high melting point, such as a combination of saturated and unsaturated oils including but not limited to coconut oil 426, palm oil 427, corn oil 428, peanut oil 429, avocado oil 430, sunflower oil 431, canola oil 432, rapeseed oil 433, sesame oil 434, grapeseed oil 435, soybean oil 436, cottonseed oil 437, olive oil 438, safflower oil 439, macadamia nut oil 440, and combinations thereof. Subsequently, as shown in FIG. 15A, the fat and oil mixture 441 is mixed and emulsified 62 with thickening ingredients 23 such as hydrocolloids 245, plant protein isolates 442, and plant fibers from various sources 258. In the preferred embodiment of the present invention, as shown in FIG. 15B, the hydrocolloids 245 are selected from sodium alginate 378, konjac glucomannan 379, xanthan gum 246, pectin 247, agar 248, carrageenan 249, gum Arabic 250, cellulose gum 251, gellan 252, guar gum 380, locust bean gum 381, tara gum 382, methylcellulose 254, maltodextrin 255, natural starches 256, modified starches 257, and combinations thereof. Alternatively, flavoring ingredients 22 such as yeast extract 231, nutritional yeast 230, hydrolyzed yeast 229, and natural flavors 227, can be added to further enhance the meaty taste. Further, transglutaminase can be employed to modify protein structure and to enable crosslinking among separate extrudate fibril protein pieces, and a meat analogue piece with greater thickness and desired fat content and texture is created to simulate thick whole cut meat.

For long-term storage at ambient conditions, the extrudate product can be dehydrated by microwave vacuum dying process, or by subsequent oven or air drying after the microwave heating process, to a moisture content of less than 15%. The dehydrated products are tested to have over 12 months of shelf life at ambient conditions, suitable for cost-efficient storage and transportation without the need for temperature control.

Commercialization Financial and Sustainability Model

Costs from manufacturing process steps comprising mixing, extrusion, shaping, flavoring, and packaging, as described in this invention, are used to build a commercialization financial model. Depending on the extruder throughput, the production volume for an 8-hr day could be up to 12,000 lbs of the finish product for a medium-scale extruder. Product variable cost mainly includes raw ingredients, packaging materials, manufacturing cost, and logistic cost from ambient and cold storages, transportation, and distribution. The model lands at retail price for the whole cut meat analogue cost comparable to beef steak cost used in cheesesteak sandwich, and would be cost efficient for customer affordability, commercialization, and further scale-up. The comparable retail price for the meat analogue also allows a low variable cost to achieve high gross margin of up to 60-70% before the inclusion of the fixed cost. The variable cost can be further reduced at larger production throughput with bigger scale commercially available extruders up to 5,200 lbs/hr output.

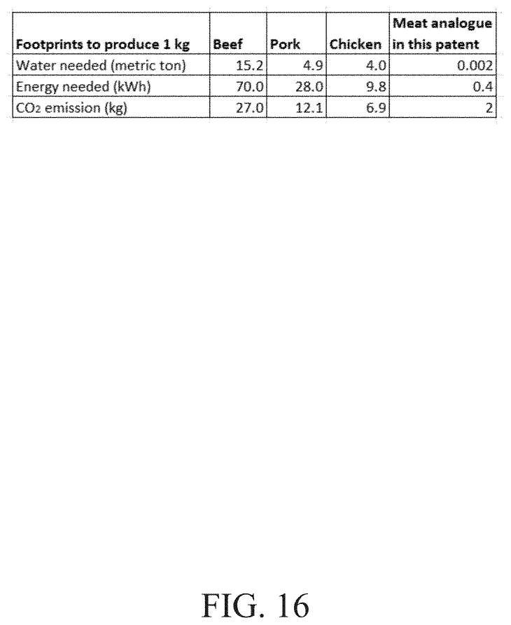

This present invention, as shown in FIG. 16, uses minimal water and energy and emits a very small amount of carbon dioxide compared to traditional agricultural animal meat production, shown in the commercialization sustainability mode. In summary, the whole cut meat analogue of the present invention can be produced within hours and scaled up easily to provide abundant supply, with similar affordability as traditional animal meat.

### EXAMPLES

The below examples are only a way to illustrate some aspects of this invention, and should not be construed to limit the scope of this invention.

### Example 1 Formulation of Proteinaceous Raw Materials to Simulate Essential Amino Acid Profile from Beef Brisket

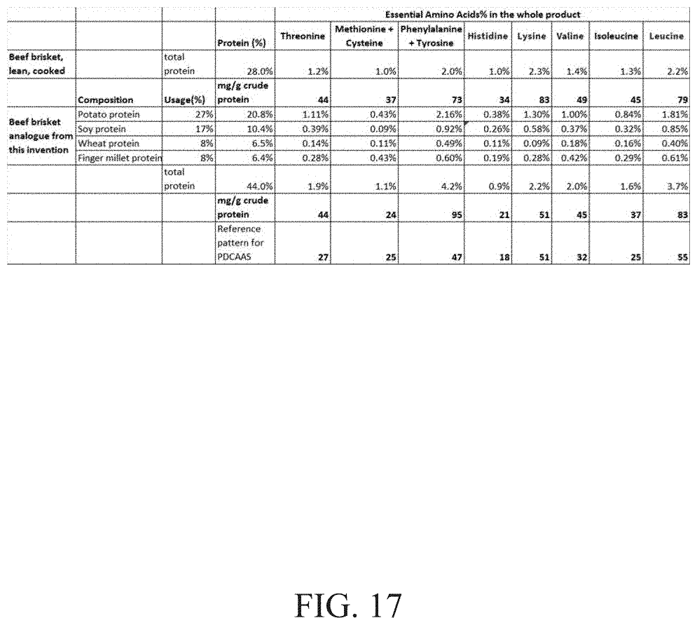

Assorted nutritious natural plant protein sources are selected and formulated 2 in desired proportions to match the essential amino acid profile from cooked lean beef brisket. The selection of the protein sources not only ensures sufficient protein content, but also complements each other to provide balanced essential amino acids with reference to the protein digestibility-corrected amino acid score (PDCAAS) value up to 1.0, an important indicator that the protein contains essential amino acids in excess of the human requirements. Methionine and lysine are typically lower in plant-based proteins than animal-based. Certain special ancient grain proteins consisting of but not limited to finger millet, lentils, and pearl millet are great sources to compensate for these essential amino acid deficiencies. Texturizing protein sources are also selected to ensure desired fibrous texture formation under high moisture extrusion 31 and extended gradient cooling process. The present invention, as shown in FIG. 17, provides an example showing that the composition of plant-based proteins and their essential amino acid profile, are at par or greater than the beef brisket, by comparing the essential amino acid content in the total protein. Further comparing the amount of essential amino acids in the crude protein with the reference pattern for PDCAAS, it is apparent that the meat analogue in this invention provides premium protein quality meeting the complete protein nutritional requirements. The protein quality simulation for other animal meat such as pork, chicken, and lamb can be achieved with the same methodology.

### Example 2 High Moisture Extrusion and Cooling Process 4

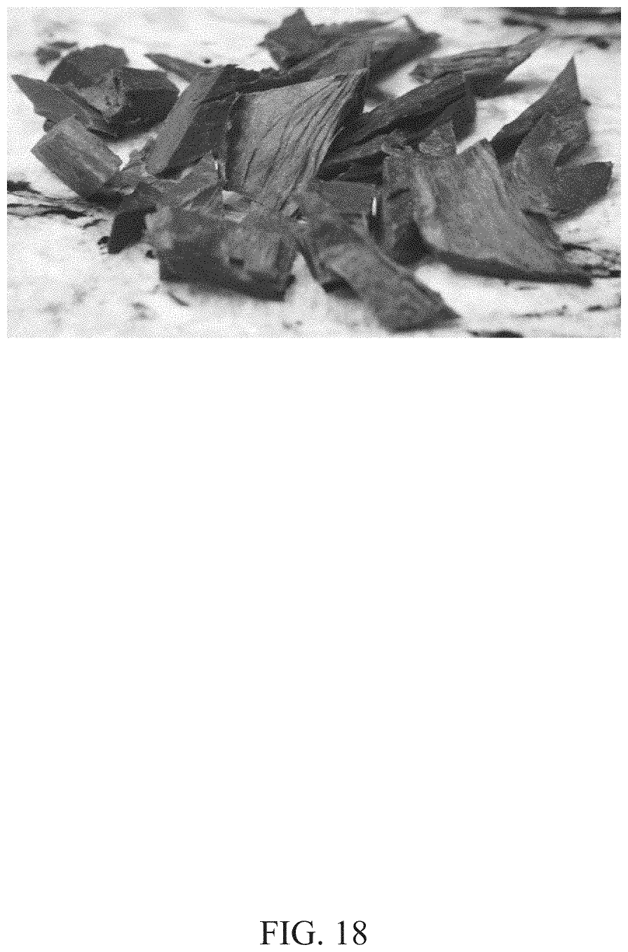

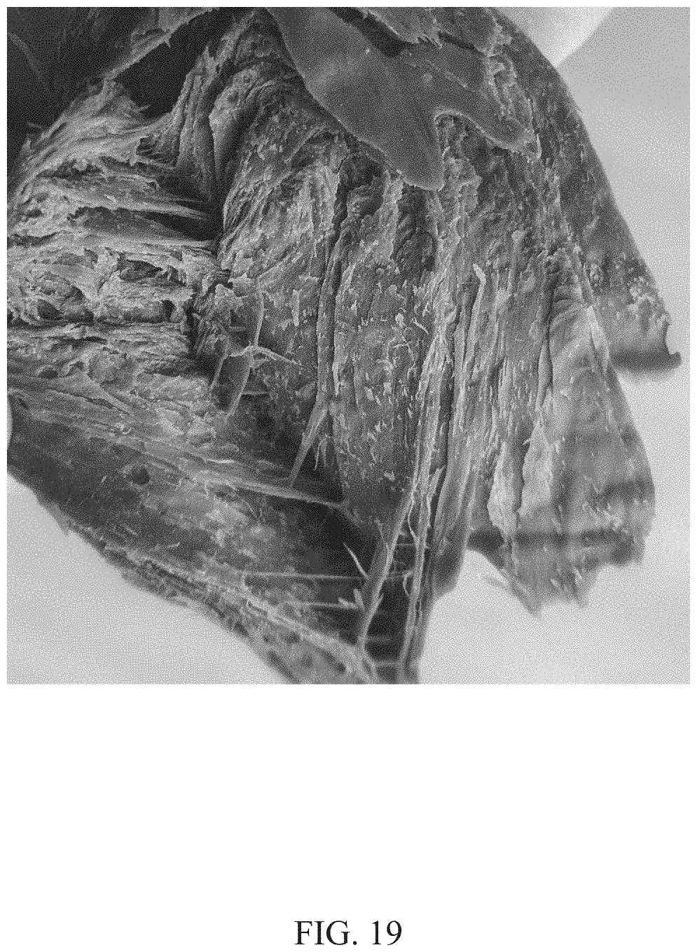

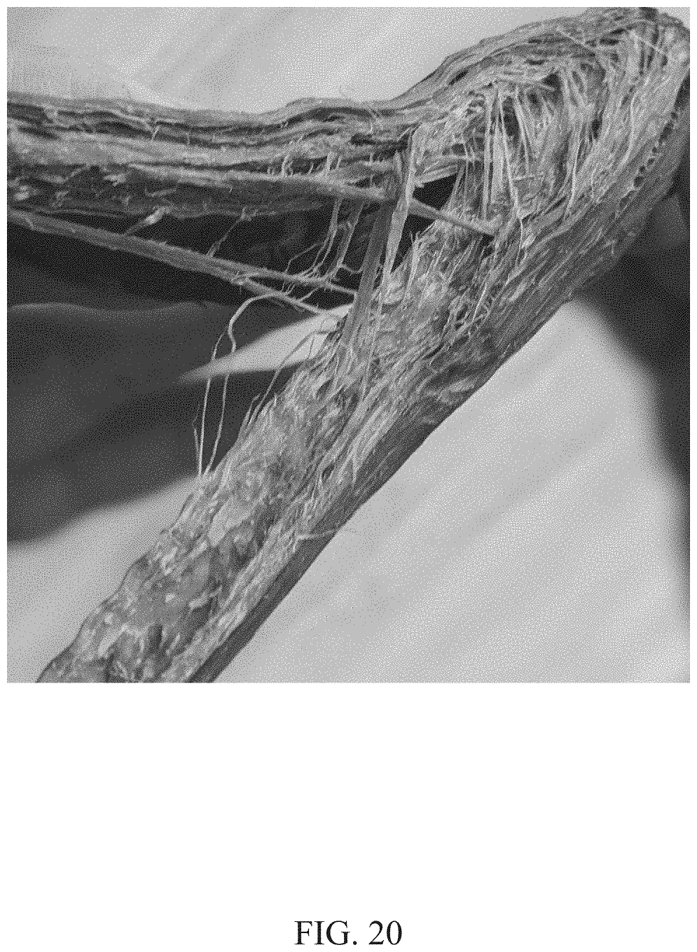

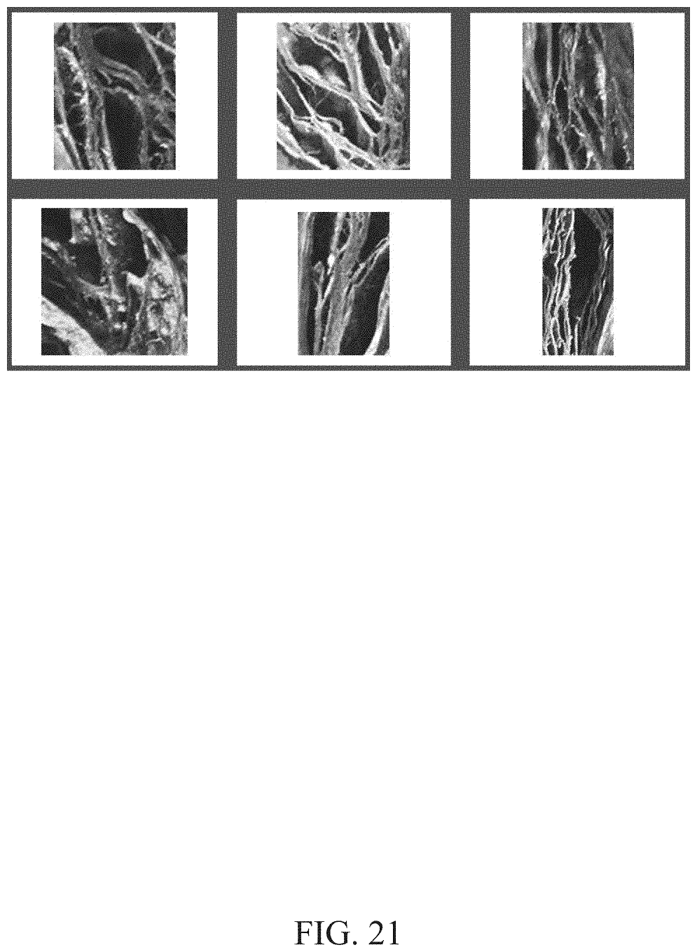

Pretreated mixture of raw ingredients, preferably the main protein sources are selected from soy, wheat, peanuts, peas, sunflower seeds, rapeseeds, highland barley extrudates, lentils, millets, with a protein content of 60-70% at dry weight basis, is fed into a twin-screw extruder at 70 kg/h, and water is fed at the same time to achieve a moisture content of 65-75%. Screw rotation speed is at 16-22 Hz, the water separator runs at 45 Hz initially and gets stabilized at 35-39 Hz, and the extruder barrel pressure is controlled within 7-10 MPa. The extrusion temperature gradually increases from ambient temperature to 50° C. through the 1^{st} to 3^{rd} segments, then to 80-85° C. for the 4^{th} segment, 145-155° C. for the 5^{th} segment, 165-170° C. for the 6^{th} and 7^{th} segments, 145-150° C. for the 8^{th} segment, 130-135° C. for the 9^{th} segment, 125-130° C. for the 10^{th} segment, and 110-120° C. for the 11^{th} segment. A counter-rotating mode is used for the twin-screw extruder at the 6^{th} and 7^{th} segments to elongate cooking time and sufficient protein molecule expansion. Cooling of the hot melt extrudate takes place by cooling water circulation and is set to 66-76° C. crossing 3 segments, and the extrudate temperature is lowered to around 70° C. A flat shaping die with a 10 mm thickness is used to produce a continuous long strip of the cooled extrudate. A 360° circular shaping die of a similar thickness is also used to improve the cooling throughput by generating greater product quantity throughout the circular plane, with a bigger surface area than a flat plane. The cooled extrudate has a moisture content of 50-55%, tightly layered fibrous structure, and meat-like elasticity, as shown in FIG. 18, FIG. 19, FIG. 20, and FIG. 21, for irregularly torn pieces from the extrudate product. The extruder input, output, screw rotation speed, and barrel pressure are dependent on the physical dimension and size of the extruder, and can be changed to achieve similar product texture and appearance.

### Example 3 Expanding Protein Structure of the Cooled Extrudate Using Microwave Vacuum Heating and Drying

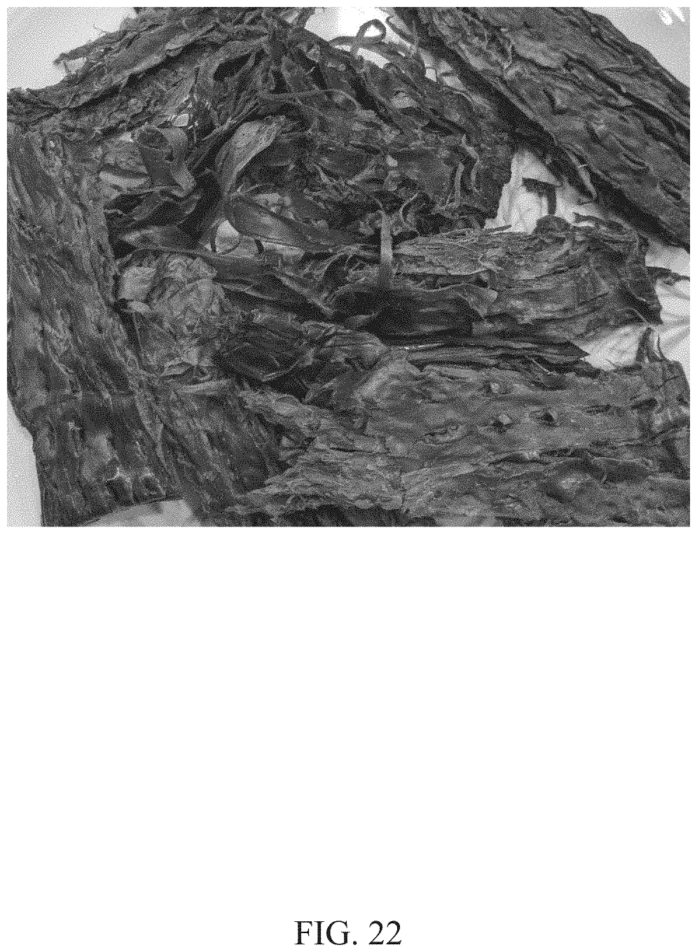

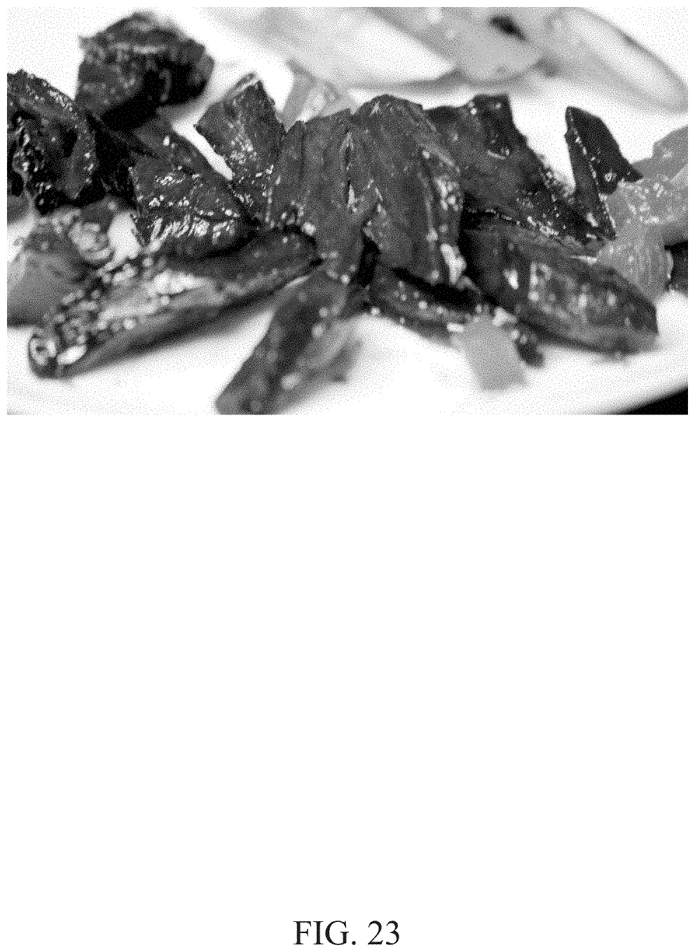

The cooled extrudate product from this invention has a dense fibrous structure and partial expansion of such structure makes the meaty flavor development process both energy and time efficient. Before the process, the product is cut into pieces with a variable width of about 15-25 mm and a variable length of about 20-80 mm, much longer than the piece thickness of 10 mm. A microwave vacuum system comprising 2 tandem microwave machines is used, and the product is conveyed at 1-1.5 meter/min with 10 kW output power and 2000 MHz of frequency from the microwave. The product is kept at 5 kPa pressure in the vacuum during the heating process to achieve an evaporation rate of 20-30 kg/h. The moisture content of the product is lowered to about 20%. The partially opened fiber structure of the expanded extrudate product, shown in FIG. 22, is much easier to soak up the flavor without the need for extensive or high-pressure cooking 6. Further, the expanded extrudate product can easily be torn mechanically to create irregular shapes and natural meat look with a fibrous structure, shown in FIG. 23. Alternatively, the cooled extrudate product can be dried to a moisture content of less than 15% by being conveyed at 3 meter/min at the same microwave and vacuum setting, followed by a 2.5 meter/min conveying speed to reach the moisture content with minimal local burning on the product. Such dried extrudate can be used for ambient temperature long-term storage over 12 months and convenient transportation.

### Example 4 Creation of Ready-to-Eat Meat Analogue to Simulate Beef Brisket Flavor, Texture and Appearance

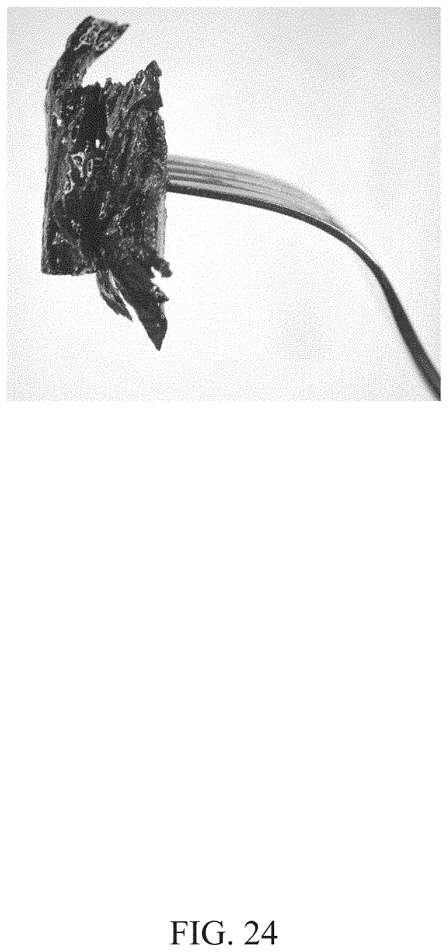

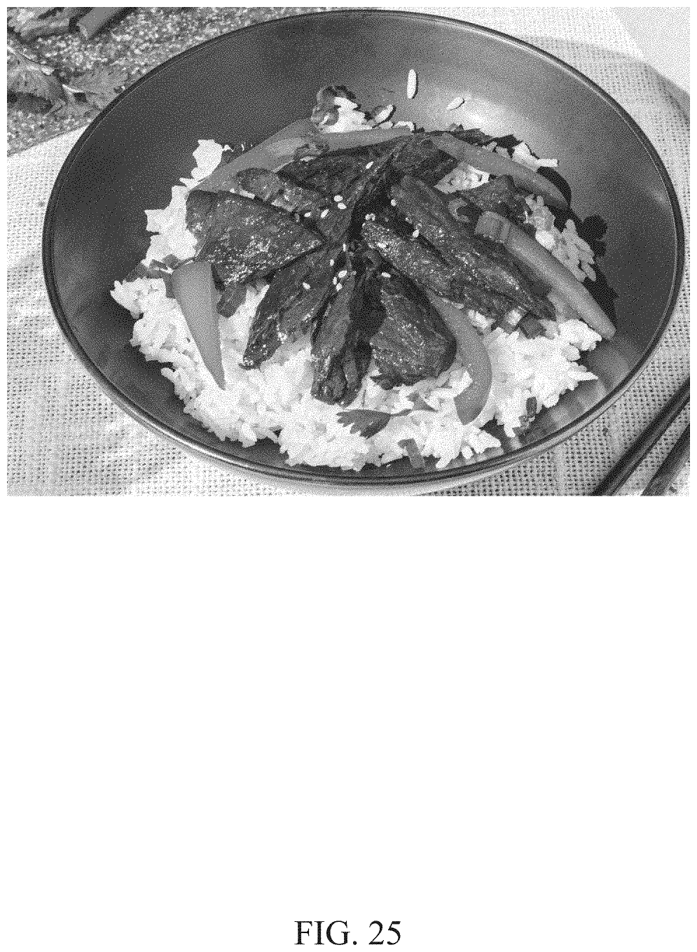

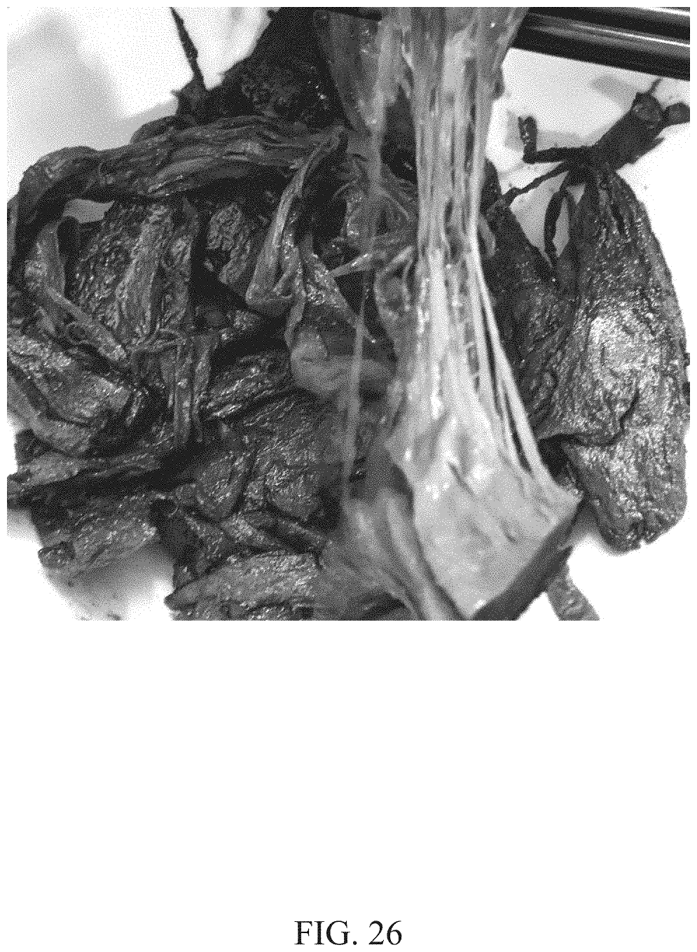

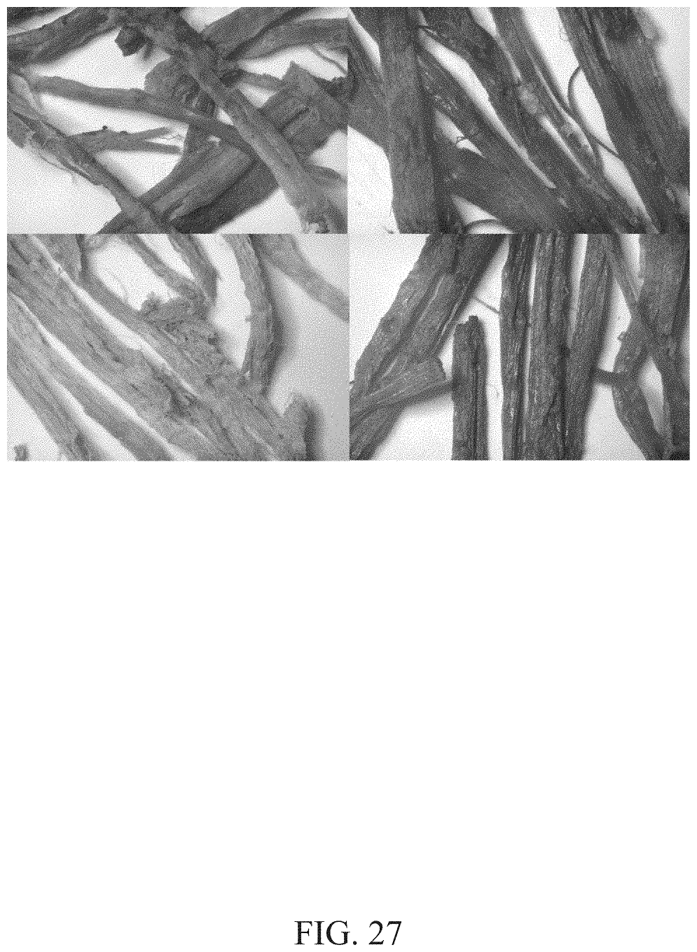

The cooled extrudate product from this invention is separated into irregular sizes, and preferably, the microwave vacuum heating process is applied to partially expand the protein fibrous structure. The sized product pieces are added to a marinating solution, including ingredients selected from the group consisting of soy sauce 224, tamari soy sauce 225, bulgogi sauce 396, fermented soybean paste 397, natural flavors 228, hydrolyzed yeast 229, yeast extract 231, nutritional yeast 230, hydrolyzed vegetable protein 232, seaweed powder 226 from such as kombu 347, nori 348, dulse 349, and wakame 350, natural plant extracts including vegetable extracts 233 such as but not limited to green tea 500, grape seeds 501, sorghum bran 502, onion 351, green onion 352, garlic 353, celery 354, carrot 355, mushroom 356, peppers 357, bell peppers 358, and tomato 359, smoke 234 and grill flavors 235, mushroom powder 398, cane sugar 215, fructooligosaccharides 399, trehalose 400, reducing sugars 271 such as fructose 342, galactose 343, maltose 344, mannose 345, and dextrose 346, syrups 218, molasses 216, sesame seed powder 394, sunflower seed powder 393, various nut powders 395, spices 218 such as laurel leaf 360, bay leaf 361, curry leaf 362, cinnamon 363, cardamom 364, clover 365, coriander 366, nutmeg 367, ginger 368, tamarind 369, cumin 370, star anise 371, fennel 372, fenugreek 373, Sichuan pepper 374, black pepper 375, white pepper 376, cayenne pepper 377, and combinations thereof. In the preferred embodiment of an alternative embodiment of the present invention, endoprotease enzymes 404, selected from alcalase 408, ficain 409, chymopapain 410, papain subtilisins 411, bromelians 412, streptopain 413, glutaminase 414, calpain 415, cathepsin 416, trypsin 417, chymotrypsin 418, elastase 419, thermolysin 420, pepsin 421, glutamyl endopeptidase 422, neprilysin 424, and combinations thereof, are first contacted and mixed with the sized product before the addition of marinating solution to allow a suitable amount of reaction time, hydrolyzing the protein in the product into peptides or amino acids to promote meaty flavor creation through Maillard reaction. The mixture is allowed to cook at 80-100 kPa pressure for a duration of about 15-30 minutes, to achieve the right meaty texture of considerable chewiness but not too tough. The marinated product is allowed to dry from the loose surface liquid, and then sent for a starch coating and frying process at 180-205° C. for 1-3 minutes to incorporate fatty notes. Additional flavoring ingredients as used in the marinating solution can be applied to enhance the desired taste. The final product has a protein content of about 30%, considerable water-holding capacity that brings a juicy bite, the right amount of chewiness and toughness similar to beef muscle meat texture and mouthfeel, tender fiber and fatty mouthfeel, and a highly alike appearance of beef brisket, as shown in FIG. 24, FIG. 25, FIG. 26, and FIG. 27. A texture profile analysis is performed on the meat analogue, which mimics the mouth's biting and chewing actions. During analysis, the cylindrical sample height was kept constant at 45 mm, and the diameter was 2 mm. Samples were compressed to 75% of their original height at a crosshead speed of 1 mm/second. The meat analogue is shown to have a similar hardness as the beef, representing the maximum force of the first impression of biting the product, with an average hardness of around 317 to 400 grams, at a moisture level of 55%-65%. An expanded view of protein fiber appearance is examined for the meat analogue, shown in the right images in FIG. 27, alongside muscle meat from beef and pork, shown in the top left image and bottom left image in FIG. 27, respectively. A comparison of these images shows strong similarity in the way these protein fibers are tightly layered in a laminar shape.

### Example 5 Meat Analogue Application as in Plant-Based Cheesesteak Sandwich

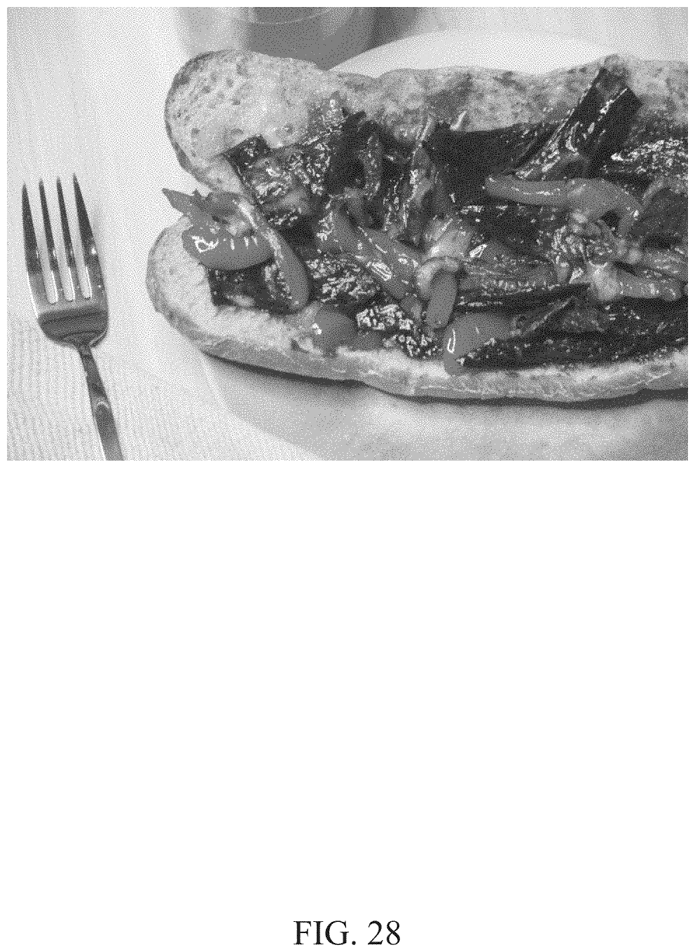

The cooled extrudate product from this invention is processed to partially expand the protein fibrous structure through microwave vacuum heating and drying, and a mechanic meat tenderization process is applied on the product to loosen the surface structure and to create the irregular meaty look. The product is size reduced to a steak strip analogue of an approximately ⅛-inch thickness suitable for cheesesteak sandwich application. The steak strip analogue is marinated and tenderized through high-pressure cooking 6. The marinating solution includes ingredients selected from the group consisting of soy sauce 224, tamari soy sauce 225, bulgogi sauce 396, fermented soybean paste 397, natural flavors 228, hydrolyzed yeast 229, yeast extract 231, nutritional yeast 230, hydrolyzed vegetable protein 232, seaweed powder 226 from such as kombu 347, nori 348, dulse 349, and wakame 350, natural plant extracts including vegetable extracts 233 such as but not limited to green tea 500, grape seeds 501, sorghum bran 502, onion 351, green onion 352, garlic 353, celery 354, carrot 355, mushroom 356, peppers 357, bell peppers 358, and tomato 359, smoke 234 and grill flavors 235, mushroom powder 398, cane sugar 215, fructooligosaccharides 399, trehalose 400, reducing sugars 271 such as fructose 342, galactose 343, maltose 344, mannose 345, and dextrose 346, syrups 218, molasses 216, sesame seed powder 394, sunflower seed powder 393, various nut powders 395, spices 218 such as laurel leaf 360, bay leaf 361, curry leaf 362, cinnamon 363, cardamom 364, clover 365, coriander 366, nutmeg 367, ginger 368, tamarind 369, cumin 370, star anise 371, fennel 372, fenugreek 373, Sichuan pepper 374, black pepper 375, white pepper 376, cayenne pepper 377, and combinations thereof. In the preferred embodiment of an alternative embodiment of the present invention, endoprotease enzymes 404, selected from alcalase 408, ficain 409, chymopapain 410, papain subtilisins 411, bromelians 412, streptopain 413, glutaminase 414, calpain 415, cathepsin 416, trypsin 417, chymotrypsin 418, elastase 419, thermolysin 420, pepsin 421, glutamyl endopeptidase 422, neprilysin 424, and combinations thereof, are first contacted and mixed with the sized product before the addition of marinating solution to allow a suitable amount of reaction time, hydrolyzing the protein in the product into peptides or amino acids to promote meaty flavor creation through Maillard reaction. The marinating mixture is allowed to cook at 80-100 kPa pressure for a duration of about 20-40 minutes, to achieve the right juicy and tender meaty texture for this application. The steak strip analogue is mixed with caramelized onions, peppers and melted vegan cheese on the top to make the plant-based cheesesteak sandwich, shown in FIG. 28.

All illustrations of the drawings are for the purpose of describing selected versions of the present invention and are not intended to limit the scope of the present invention. Although the invention has been explained in relation to its preferred embodiment, it is to be understood that many other possible modifications and variations can be made without departing from the spirit and scope of the invention.

It will be apparent to those skilled in the art that various modifications and variations can be made in the practice of the present invention without departing from the scope or spirit of the invention. Other embodiments of the invention will be apparent to those skilled in the art from considering the specification and practice of the invention. It is intended that the specification and examples be considered as exemplary only, with a true scope and spirit of the invention being indicated by the following claims.

What is claimed is:

1. A method of preparing a plant-based whole cut meat analogue with a muscle-like fibrous structure, a muscle-like elasticity, nutritionally balanced amino acid profile, and meaty flavors, using naturally occurring and available plant protein sources and other plant-based ingredients, without genetic engineering and cell cultivation, that simulates the essential amino acid composition of the protein content and a texture, color, and flavor of animal products including beef, chicken, pork, and lamb comprising the steps:
formulating; and
high moisture extruding and cooling;
the process of formulating, wherein a mixture of raw food material comprising an at least one plant proteinaceous material composing 20% to 90% per dry weight basis, an at least one flavoring and coloring ingredient, and an at least one thickening and stabilizing ingredient are chosen in a predetermined quantity; and
the high moisture extruding and cooling process wherein the formulated mixture at a water content of 35%-80%, undergoes the steps of a precisely designed extrusion and cooling process over multiple temperature segments, wherein the mixture is formed into an extrudate, with elongated and solidified protein fibrous structure of a predetermined toughness and a predetermined chewiness to simulate whole cut meat.

2. The method as claimed in claim 1, further comprising forming a meat analogue extrudate having a moisture content of 35% to 70%, a protein content of 11%-45%, a tight layered fibrous structure, and a meat-like elasticity;

3. The method as claimed in claim 1, further comprising a post-treating process, wherein said post-treating comprises:
forming a fibrous structure into predetermined shapes and sizes;
conditioning an expansion of the dense fibrous structure for flavor incorporation;
infusing, into a matrix of the fibrous structure, ingredients from a group consisting of natural flavors, reaction flavors, or a combination thereof; and
creating a whole cut meat analogue with a fat inclusion and a thickness.

4. The method of claim 1, wherein the at least one plant proteinaceous material is chosen from a group consisting of:
cereals such as wheat, teff, emmer wheat, corn, barley, farro, oat, rice varieties such as rice, brown rice, red rice, short-grain rice, basmati rice, long-grain rice, and wild rice; tuber and root plants such as potato, sweet potato, yam, cassava, yuca, carrot, lotus root, taro, turnip; legumes such as chickpea, soy, pea, pigeon pea, yellow pea, green pea, snow pea, peanut, lentil varieties such as red lentil, green lentil, brown lentil, yellow lentil, puy lentil, black lentil, and horse gram, millet varieties such as finger millet, pearl millet, foxtail millet, little millet, kodo millet, barnyard millet, proso millet, fonio millet, and Italian millet, bean varieties such as fava bean, mung bean, adzuki red bean, kidney bean, black-eye bean, black bean, pinto bean, lima bean, moth bean, navy bean, cannellini bean, white bean, cranberry bean, lupin bean; plant seeds such as buckwheat, quinoa, chia seeds, amaranth, canola seeds, rapeseeds, flaxseeds, sesame seeds, sunflower seeds, pumpkin seeds, hemp seeds, cotton seeds, fenugreek; nuts such as almonds, cashews, pecan, walnut, pine nut, macadamia nut, pistachio, Brazil nuts, hazelnut; algae, mushrooms, extrudates from plant proteinaceous material, texturized protein, and combinations thereof;
the at least one flavoring and coloring ingredient is chosen from a group consisting of:
cane sugar, molasses, reducing sugars such as fructose, galactose, maltose, mannose and dextrose, syrups, caramel color, salt, peptides, amino acids, nucleotides, soy sauce, tamari soy sauce, seaweed powder from such as kombu, nori, dulse, and wakame, natural colors, natural flavors, hydrolyzed yeast, nutritional yeast, yeast extract, hydrolyzed vegetable protein, natural plant extracts including vegetable extracts such as but not limited to green tea, grape seeds, sorghum bran, onion, green onion, garlic, celery, carrot, mushroom, peppers, bell peppers, and tomato, smoke and grill flavors, spices such as laurel leaf, bay leaf, curry leaf, cinnamon, cardamom, clover, coriander, nutmeg, ginger, tamarind, cumin, star anise, fennel, fenugreek, Sichuan pepper, black pepper, white pepper, cayenne pepper, and combinations thereof; and
the at least one thickening and stabilizing ingredient is chosen from the group consisting of:
calcium sulfate, calcium lactate, sodium phosphate, sodium triphosphate, phosphoric acid, dipotassium phosphate, potassium bicarbonate, soy lecithin, hydrocolloids such as sodium alginate which can gel with calcium, konjac glucomannan which can gel in alkali condition, xanthan gum, pectin, agar, carrageenan, gum arabic, cellulose gum, gellan, galactomannans including but not limited to guar gum, locust bean gum, and tara gum, methylcellulose, maltodextrin, natural starches, modified starches, plant fibers from sources such as but not limited to lemon, lime, orange, grapefruit, pea, corn, oat, soy, rice, potato, plantain, coconut, carrot, mushrooms, Norwegian kelp, psyllium, and combinations thereof.

5. The method of claim 4, further including extending the protein sources to include proteins from yeast, fish, chicken, and beef, and demonstrating a feasibility of using the invented method herein in creating a unique muscle-like fibrous texture from broader protein sources.

6. The method as claimed in claim 1, wherein the high moisture extrusion process comprises:
feeding the formulated mixture at a water content of 35%-80%;
cooking over multiple temperature-controlled and evenly spaced segments in an extrusion barrel comprising:
cooking the mixture at a temperature between 30° C. and 50° C.;
increasing the temperature from between 80° C. and 90° C. to between 140° C. and 150° C.;
increasing the temperature to between 160° C. and 175° C.;
decreasing the temperature to between 130° C. and 150° C.;
allowing the temperature to decrease to between 110° C. and 120° C.;

7. The method of claim 6, further including using a counter-rotating mode for a twin-screw extruder at the highest temperature segment, to slow down the mixture transfer rate to increase cooking time, allowing more sufficient expansion of protein molecules and subsequently stronger fiber structure and network.

8. The method of claim 1, wherein the cooling process comprises:
pushing the hot melt extrudate into a cooling chamber comprising multiple segments to cool at a temperature between 50° C. and 90° C.;
lowing the extrudate to a temperature below 70° C.;
realigning, solidifying, and forming elongated and layered protein fiber molecular structure along the laminar flow, shaping and forming the cooled extrudate using a shaping die, wherein said shaping die is selected from the group consisting of:
a flat shaping die wherein the extrudate forms a long continuous strip; and
a 360° circular shaping die thus generating an extruded product through a circular plane.

9. A method of preparing a plant-based whole cut meat analogue with a muscle-like fibrous structure, a muscle-like elasticity, nutritionally balanced amino acid profile, and meaty flavors, using naturally occurring and available plant protein sources and other plant-based ingredients, without genetic engineering and cell cultivation, that simulates the essential amino acid composition of the protein content and a texture, color, and flavor of animal products including beef, chicken, pork, and lamb comprising the steps:
formulating;
high moisture extruding and cooling; and
modifying the texture and flavor of the meat analogue;
the process of formulating, wherein a mixture of raw food material comprising an at least one plant proteinaceous material, an at least one flavoring and coloring ingredient, and an at least one thickening and stabilizing ingredient are chosen in a predetermined quantity;
the high moisture extruding and cooling process wherein the formulated mixture at a water content of 35%-80%, undergoes the steps of a precisely designed extrusion and cooling process over multiple temperature segments, wherein the mixture is formed into an extrudate, with elongated and solidified protein fibrous structure of a predetermined toughness and a predetermined chewiness to simulate whole cut meat;
the process of modifying the texture and flavor of the meat analogue creating versatile shapes, forms, and flavors suitable for various plant-based whole cut meat applications from different animal origins.

10. The method as claimed in claim 9, further comprising cutting, tearing, and shaping into various whole cut meat analogue forms, such as but not limited to meaty chunks, sliced beef steak, pulled meat, and schnitzel.

11. The method as claimed in claim 9, further comprising treating the extrudate product with microwave vacuum heating and drying process to achieve a desired partial expansion of the dense fiber structure mainly around the piece thickness, while reducing the moisture content of the product from over 40% to less than 20% and to create porous structure, promoting more efficient juicy flavor infusion without the need for extensive or high-pressure cooking.

12. The method as claimed in claim 9, further comprising mechanically tearing and cutting the expanded extrudate product into pieces of desirable sizes and creating irregular shapes and natural meat look with a fibrous structure.

13. The method as claimed in claim 9, further comprising dehydrating the extrudate product to a moisture content less than 15% by a microwave vacuum dying process or by a subsequent process chosen from the group consisting of an oven drying process and an air drying process, after the microwave vacuum puffing heating process, for long-term storage with over 12 months of shelf life at ambient conditions, suitable for cost-efficient storage and transportation without the need for temperature control.

14. The method as claimed in claim 9, further comprising generating a reaction flavor of the animal protein to simulate, and infusing such flavor into the extrudate product, comprising of the steps:
The extrudate product of desired shape and size is added into a marinating solution comprising 1% to 8% ingredients high in sulfur-containing amino acids and at least one secondary ingredient; and
The mixture is allowed to react at a temperature greater than 100° C. and a pressure of less than or equal to 105 kPa;
The ingredients high in sulfur-containing amino acids selected from the group consisting of:
sunflower seed powder, sesame seed powder, and various nut powders, together with reducing sugars such as fructose, galactose, maltose, mannose and dextrose, natural flavors, hydrolyzed yeast, yeast extract, nutritional yeast, hydrolyzed vegetable protein, seaweed powder from such as kombu, nori, dulse, and wakame, natural plant extracts including vegetable extracts such as but not limited to green tea, grape seeds, sorghum bran, such as, but not limited to onion, green onion, garlic, celery, carrot, mushroom, peppers, bell peppers, and tomato, smoke and grill flavors, and combinations thereof;
and secondary ingredients selected from the group consisting of:
soy sauce, tamari soy sauce, bulgogi sauce, fermented soybean paste, mushroom powder, cane sugar, fructooligosaccharides, trehalose, syrups, molasses, spices such as laurel leaf, bay leaf, curry leaf, cinnamon, cardamom, clover, coriander, nutmeg, ginger, tamarind, cumin, star anise, fennel, fenugreek, Sichuan pepper, black pepper, white pepper, cayenne pepper, and combinations thereof;

15. The method of claim 14, further comprising a method selected from the group consisting of marinating, cooking, and mechanic meat tenderization, wherein said method is performed with 0.5%-8% natural flavors at weight basis of a final product simulating animal meat flavors, selected from the base, middle, top notes flavors, and combinations thereof, for flavor infusion into the expanded extrudate product, preferably at 105° C. for 20 min to sterilize the product as well as to infuse flavors.

16. The method of claim 14, further comprising analyzing volatiles, semi-volatiles, and other chemical compositional attributes that correlate the flavor performance to that of respective animal protein, and adjusting reaction ingredients and pressure and temperature conditions to match desired flavor performance for the animal meat to simulate.

17. The method of claim 14, further comprising:
before the high-pressure treatment, adding proteolytic enzymes selected from the group consisting of:
endopeptidases, exopeptidases, endoproteases, exoproteases, endogenous enzymes, exogenous enzymes, and combinations thereof; and
hydrolyzing a protein substrate into at least one product selected from the group consisting of peptides and amino acids;
wherein endogenous enzymes are selected from the group consisting of alcalase, ficain, chymopapain, papain subtilisins, bromelians, streptopain, glutaminase, calpain, cathepsin, trypsin, chymotrypsin, elastase, thermolysin, pepsin, glutamyl endopeptidase, serratiopeptidase, neprilysin, and combinations thereof,
wherein said enzyme hydrolysis promotes meaty flavor creation through the Maillard reaction, opens protein inner structure, results in a desired tenderness and texture, and enables easy incorporation of flavoring juice and fat within the protein matrix, highly mimicking juicy and fatty mouthfeel of the real meat.

18. The method as claimed in claim 9, further comprising the step of creating a meat analogue for greater thickness desired fat content and structure, wherein said process comprises:
expanding the protein fiber structure and mechanically tearing the meat analogue into a plurality of pieces of predetermined size;
mixing the pieces of predetermined size with an emulsion that simulates animal fat and texture;
heating the pieces of predetermined size to form an emulsion gel, stabilizing a protein and imitation fat matrix, and forming a solid protein gel network encapsulating and assembling fat into the partially opened protein fibrous structure for fatty mouth feel simulation;
the emulsion is comprised of a mixture of vegetable fats and oils with a relatively high melting point such as a combination of saturated and unsaturated oils selected from the group consisting of:
coconut oil, palm oil, corn oil, peanut oil, avocado oil, sunflower oil, canola oil, rapeseed oil, sesame oil, grapeseed oil, soybean oil, cottonseed oil, olive oil, safflower oil, and macadamia nut oil.
and subsequently emulsified with thickening ingredients selected from the group consisting of:
hydrocolloids, plant protein isolates and plant fibers from various sources, wherein preferable hydrocolloids are selected from sodium alginate, konjac glucomannan, xanthan gum, pectin, agar, carrageenan, gum arabic, cellulose gum, gellan, guar gum, locust bean gum, tara gum, methylcellulose, maltodextrin, natural starches, modified starches, and combinations thereof.

19. The method of claim 18, further comprising adding flavoring ingredients such as yeast extract, nutritional yeast, hydrolyzed yeast, and natural flavors, to further enhance the meaty taste.

20. The method of claim 18, further comprising employing transglutaminase to modify protein structure and to enable crosslinking among separate extrudate fibril protein pieces, and to simulate thick whole cut meat analogue with greater thickness and desired fat content and structure.

21. The method as claimed in claim 1, further comprising modeling a cost-efficient financial model for manufacturing the whole cut meat analogue into a commercial product with fast scalability, high affordability, and high sustainability.

22. A plant-based whole cut meat analogue produced according to the method of claim 1, wherein said meat analogue has muscle-like fibrous structure and elasticity, nutritionally balanced amino acid profile, and meaty flavors, using naturally occurring and available plant protein sources and other plant-based ingredients, without genetic engineering and cell cultivation, comprising:
between about 11% and about 45% by weight of protein content, and between about 35% and about 70% by weight of water;
tight-layered elongated protein anisotropic fibers with large longitudinal strength and laminar shape of about 5-15 mm of thickness; greater thickness created through restructuring and crosslinking meat analogue with imitation fat upon novel post processing;
similar juiciness, firmness, elasticity, appearance, and protein nutritional value in comparison to animal meat equivalent;
layered sophisticated flavor profiles from the inside matrix to the outside topical flavor mimicking organoleptic satisfaction from animal meat taste; and
versatile shapes, forms, and flavors suitable for various plant-based whole cut meat applications from different animal origins;

23. The plant-based whole cut meat analogue of claim 22, wherein the formulations do not challenge common nutritional sensitivities such as gluten or soy.

24. The plant-based whole cut meat analogue of claim 22, wherein mushroom stem fiber and barley extrudates are used to promote fiber structure formation and to enhance anti-freeze properties, particularly resulting in enhanced fiber tightness, pore size, and moisture retention.

25. The plant-based whole cut meat analogue of claim 22, wherein the optimal composition of legume proteins and wheat gluten is used to promote muscle-like fiber formation and to achieve desirable sensory properties and elasticity.

26. The plant-based whole cut meat analogue of claim 22, wherein suitable ratios of protein and carbohydrate are used to show impact on fibril protein formation and texture toughness required to simulate various types of animal meat.

27. The plant-based whole cut meat analogue of claim 22, wherein longitudinal strength and fiber structure organization of the protein fiber formation is optimized for animal meat simulation, through controlling the impact of high-temperature phase during the extrusion process.
